(19) United States
(12) Patent Application Publication
(10) Pub. No.: US 2015/0260908 A1
(43) Pub. Date: Sep. 17, 2015

(54) DISPLAY APPARATUS AND LIQUID-CRYSTAL DISPLAY APPARATUS

(71) Applicant: SHARP KABUSHIKI KAISHA, Osaka-shi, Osaka (JP)

(72) Inventor: Daisaku Kiguchi, Osaka-shi (JP)

(73) Assignee: SHARP KABUSHIKI KAISHA, Osaka-shi, Osaka (JP)

(21) Appl. No.: 14/432,117

(22) PCT Filed: Sep. 27, 2013
(86) PCT No.: PCT/JP2013/076390

§ 371 Date: Mar. 27, 2015

(30) Foreign Application Priority Data
Sep. 28, 2012 (JP) 2012-218143
Sep. 28, 2012 (JP) 2012-218146
Sep. 28, 2012 (JP) 2012-218147
Sep. 28, 2012 (JP) 2012-218148
Sep. 28, 2012 (JP) 2012-218149
Sep. 28, 2012 (JP) 2012-218181
Sep. 26, 2013 (JP) 2013-200464

(51) Int. Cl. F21V 8/00; G02F 1/1333; G02F 1/1335

(52) U.S. Cl. CPC G02B 6/0088; G02F 1/1336; G02B 6/0051; G02B 6/009; G02F 1/133308; G02F 2001/133314

(57) ABSTRACT

Provided is a display apparatus in which an optical member is precisely positioned and fixed to a backlight chassis without an additional work such as a molding process or screwing.

The display apparatus, including a display panel with a front surface displaying an image, an optical sheet 5 located on the rear surface side of the display panel to diffuse light and make the light enter the display panel, a holding body 1 formed in a box shape for holding the rear surface and side surfaces of the display panel, and a positioning member 6 having a side plate part interposed between a side surface of the optical sheet 5 and a side surface of the holding body 1, and a front plate part which is in parallel with the front surface of the display panel, for determining the position of the optical sheet 5 in a plane direction, is characterized in that a convex part 51a for positioning is provided at a marginal part of the optical sheet 5 to protrude in the plane direction, and a cutout 62b into which the convex part 51a is loosely inserted is formed at the front plate part.

### CROSS-REFERENCE TO RELATED APPLICATIONS

This application is the national phase under 35 U.S.C. §371 of PCT International Application No. PCT/JP2013/076390 which has an International filing date of Sep. 27, 2013 and designated the United States of America.

### TECHNICAL FIELD

The present invention relates to a display apparatus including a display panel, an optical sheet for diffusing light and making the light enter the display panel, and a holding body having a box-like shape and holding the rear surface and side surfaces of the display panel.

### BACKGROUND ART

One of display apparatuses includes a liquid-crystal display apparatus. A liquid-crystal panel used in the liquid-crystal display apparatus needs a backlight for displaying an image, since the liquid-crystal panel itself does not emit light. An example of the type for making light enter the liquid-crystal panel is an edge light type.

In the edge light type, a reflection sheet, a light guide plate, an optical sheet and a liquid-crystal panel are laminated in a box-shaped back light chassis, light from a light source such as an LED enters from a side surface of the light guide plate, and the liquid-crystal panel is irradiated with the light through the reflection sheet and light guide plate.

It is necessary in the edge light type to precisely assemble the light source, light guide plate and optical sheet. This is because inappropriate positional relationship among them would cause the luminance of the image displayed on the liquid-crystal panel to be lower, uneven and the like.

To address this, Japanese Patent Application Laid-Open No. 2008-84714 describes a display apparatus in which a convex part is formed on a light control sheet (optical sheet), which is fitted into a concave part formed at a frame for positioning.

### BRIEF SUMMARY OF THE INVENTION

### Problems to be Solved

Meanwhile, in recent years, a display apparatus has been reduced in its thickness, weight, and narrowed in its border width. To realize such features, for a liquid-crystal display apparatus of the edge light type, a display apparatus has been put into practice in which a reflection sheet, a light guide plate, an optical sheet and a display panel layered one on top of another in a back light chassis are fixed by holding them between the frame and backlight chassis. Since a rear cabinet made of resin covering the back surface and side surfaces of the backlight chassis, which was provided in the conventional display apparatus, is eliminated, the thickness in the front-back direction is reduced, thereby realizing thinning of the apparatus. Moreover, the dimensions in the height direction and horizontal direction correspond to values substantially conforming to the dimensions of the display panel, which realizes narrowing in the border width.

Also in the display apparatus as described above, it is necessary to precisely assemble the light source, light guide plate and optical sheet. In the display apparatus described in Japanese Patent Application Laid-Open No. 2008-84714, however, the light guide plate is fixed by a molding process to a case frame formed with resin. On the other hand, as the backlight chassis is formed with an iron plate in consideration of its strength and cost, the structure disclosed in Japanese Patent Application Laid-Open No. 2008-84714 cannot be employed.

The present invention has been made in view of the circumstances as described above, and aims to provide a display apparatus in which a light guide plate, an optical sheet and the like are precisely positioned and fixed in a backlight chassis without a molding process or screwing, while attempting reduction in the thickness and border width.

The present invention relates to a liquid-crystal display apparatus with a configuration in which a light source is located on the side of a side surface of a liquid-crystal panel.

In recent years, further reduction in the thickness, weight and border width of a display apparatus has been in progress. Since a display apparatus using a liquid-crystal panel needs to mount a backlight thereto, thinning thereof is more difficult compared to, for example, an organic EL (Electro-Luminescence) display apparatus. In order to reduce the thickness of the liquid-crystal display apparatus, such a configuration is possible that an optical member such as a light guide plate is placed on the back surface of a liquid-crystal panel and a light source such as an LED (Light Emitting Diode) is located on the side of a side surface of the optical member. This corresponds to the configuration of a liquid-crystal display apparatus with a so-called edge light type.

Japanese Patent Application Laid-Open No. 2006-216244 proposes a liquid-crystal display apparatus which decreases the temperature rise by dissipating heat generated by an LED light source to suppress lowering of the light emission efficiency. The liquid-crystal display apparatus is configured as the edge light type and has such a configuration that multiple LED light sources are mounted on an interconnection plate in an array, while a heat dissipator provided on each of the both surfaces of the interconnection plate is in direct contact with a frame.

While a light source is located on the side of a side surface of a liquid-crystal panel in the liquid-crystal display apparatus of the edge light type, the side surface parts at a casing or the like of the liquid-crystal display apparatus are the parts highly possible to be touched by the user when, for example, carrying the apparatus. A problem arises in that the heat generated by the light source is transferred to these portions, which increases the temperature at the portions touched by the user. The liquid-crystal display apparatus described in Japanese Patent Application Laid-Open No. 2006-216244 also has a similar problem, since the heat is transferred from an interconnection substrate through a heat dissipator to the frame, which further transfers the heat to the casing or the like.

In order to solve the problems as described above, complete shielding of the heat transferred from the light source to the casing or the like of the liquid-crystal display apparatus may be possible. In such a configuration, however, the temperature inside the liquid-crystal display apparatus rises due to the heat generated by the light source, causing a problem of accelerating the degradation of the light source and the other components.

The present invention has been made in view of the circumstances described above, and aims to provide a liquid-crystal display apparatus capable of appropriately transmitting the heat generated from the light source to the outside.

The present invention relates to a liquid-crystal display apparatus having a configuration in which a light source is located on the side of a side surface of a liquid-crystal panel.

In recent years, further reduction in the thickness, weight and border width of a display apparatus has been in progress. Since a display apparatus using a liquid-crystal panel needs to mount a backlight thereto, thinning thereof is more difficult compared to a display apparatus using, for example, an organic EL (Electro-Luminescence) panel which is a self-light-emitting type. In order to reduce the thickness of the liquid-crystal display apparatus, such a configuration is possible that an optical member such as a light guide plate is located on the back surface of a liquid-crystal panel and a light source such as an LED (Light Emitting Diode) is located on the side of a side surface of the optical member. This corresponds to the configuration of a liquid-crystal display apparatus of a so-called edge light type (see Japanese Patent Application Laid-Open No. 2006-216244, for example).

The conventional liquid-crystal display apparatus is configured to have a supporting member for supporting a liquid-crystal panel, which is interposed between the liquid-crystal panel and an optical member such as a light guide plate. Such a configuration is also employed in the liquid-crystal display apparatus described in Japanese Patent Application Laid-Open No. 2011-107442. Thus, in order to reduce the thickness of the liquid-crystal display apparatus, it may be possible to eliminate the supporting member for the liquid-crystal panel and to arrange the liquid-crystal panel and the optical member being in contact with each other allowing no gap between them, so as to reduce the thickness of the liquid-crystal display apparatus.

If, however, the liquid-crystal display apparatus of the edge light type is so configured that the liquid-crystal panel and optical sheet are arranged in contact with each other as described above to further narrow the frame border width, a problem arises in that the light emitted from the light source easily leaks to the outside from the border part of the liquid-crystal panel.

The present invention has been made in view of the circumstances described above, and aims to provide a liquid-crystal display apparatus which can prevent the light from the light source, light guide plate or the like from leaking to the outside and can realize reduction in thickness and border width.

The present invention relates to a display apparatus in which a light guide plate and an LED light source are fixed in a backlight chassis.

In recent years, further reduction in the thickness, weight and border width of a display apparatus has been desired. An example of a display apparatus which realized the need is provided with a backlight chassis formed to have a box shape in which a reflection sheet, a light guide plate, an optical sheet and a display panel are layered one on top of another. The display apparatus has an outer appearance of a size conforming to an optical member such as a display panel or the like, enabling thinning of the apparatus.

In the display apparatus to which light from a light source is supplied to a display panel through a light guide plate, it is necessary to precisely position each optical member. This is because the distance between the light source and the light guide plate causes the amount of light entering from the light source to the light guide plate to change. In the case where the amount of light entering the light guide plate is insufficient, the luminance of the display panel will be insufficient. The insufficient luminance of the display panel leads to degrading of the performance.

The backlight chassis is, however, formed by pressing a steel plate in terms of its strength and cost. The press work is not as precise as resin molding, and thus a complicated shape cannot easily be formed. It is, therefore, difficult to form, in the backlight chassis, a fixing structure which can determine the position of an optical member with high precision.

To address this, Japanese Patent Application Laid-Open No. 2005-173302 describes a display apparatus in which a frame is attached on a rear frame (corresponding to a backlight chassis) via a reflection sheet, an LED light source and one end surface of a light guide plate are located inside the frame while being opposed to each other and close to or in close contact with each other. The display apparatus includes an elastic means for pressing the light guide plate to the LED light source to a side opposite to the side where the one end surface is opposed to be close to or in close contact with the LED light source, and a positioning means for determining the position of the light guide plate.

In the display apparatus described in Japanese Patent Application Laid-Open No. 2005-173302, however, the border width has not been reduced, since a frame is used for fixing the LED light source and light guide plate. Moreover, using the elastic means, the light guide plate is made close to or be in close contact with the LED light source. Though the light guide plate expands by the heat generated from the LED light source, it is possible that an internal stress is generated on the light guide plate as the LED light source is made close to or be in close contact with the light guide plate using the elastic means, which may cause defects such as deformation.

The present invention has been made in view of the circumstances described above, and aims to provide a display apparatus including a structure for fixing a light guide plate and an LED light source to a backlight chassis, which is a structure capable of precisely determining the position of the light guide plate with respect to the LED light source.

The present invention relates to a display apparatus including a display panel, a light guide plate for irradiating the display panel, a holding body for holding the light guide plate, a fixing member for fixing the light guide plate to the holding body, and a frame body covering the surface peripheral part of the display panel, and also to a television receiver including the display apparatus.

In recent years, the thickness, weight and border width of a display apparatus has been reduced. As a display apparatus to realize such reduction, Japanese Patent Application Laid-Open No. 2002-221704 describes a display apparatus provided with a backlight chassis formed to have a box shape in which a reflection sheet, a light guide plate, an optical sheet and a display panel are layered one on top of another and are fixed by holding them between a front frame and the backlight chassis. Since a rear cabinet made of resin covering the back surface and side surfaces of the backlight chassis, which was provided in the conventional display apparatus is eliminated, the thickness in the front-back direction is reduced, thereby realizing thinning of the apparatus. Moreover, the dimensions in the height direction and horizontal direction correspond to values substantially conforming to the dimensions of the display panel, which realizes narrowing in the border width.

In the display apparatus as described in patent Document 5, the display panel is fixed by being sandwiched between the front frame and backlight chassis together with other components in the front-back direction. No screw is used to fix the display panel. Moreover, a space sufficient to place a regulation member for fixing and holding the display panel to the front frame or backlight chassis in order to realize the reduction in border width cannot be secured. Therefore, the display panel cannot sufficiently be prevented from being out of position.

The present invention has been made in view of the circumstances as described above, and aims to provide a display apparatus, in which the display panel is fixed without using screws, for preventing the display panel to be out of position, and a television receiver including the display apparatus.

The present invention relates to a display apparatus and a television receiver having a backlight of an edge light type.

The liquid-crystal display apparatus has features of a reduced thickness and low power consumption, has been widespread as a display in place of the conventional CRT, and also has been widely used as an image display apparatus for a television receiver (hereinafter referred to as a TV receiver). Unlike a self-emitting device, the liquid-crystal display apparatus needs a backlight as a light source, to display an image by controlling the light transmittance decided by the electro-optical characteristics of liquid crystal.

Backlight includes an edge light type (side light type, light guide plate type) and a direct type.

An example of a liquid-crystal display apparatus having a backlight of an edge light type includes a display module covered with a frame, in which a backlight unit formed with a rectangular box-like backlight chassis accommodating a light guide plate, an optical sheet and an LED substrate therein is arranged on the back surface of a liquid-crystal display panel (hereinafter referred to as a display panel) in order to realize reduction in thickness, weight and border width. The LED substrate is configured by mounting multiple LEDs on a flat surface of a long and narrow substrate. In the case where the backlight unit is a one-sided edge light type, the LED substrate is placed on one long side surface of a light guide plate having the shape of a rectangular plate. The light emitted from the LED and entering a long side surface of the light guide plate is output from the main surface of the light guide plate, to irradiate the back surface of the liquid-crystal display panel.

While the configuration as described above realizes reduction in the thickness and border width as the thickness of the liquid-crystal display apparatus is substantially equal to the total thickness of the optical members of the display panel, a problem arises in that a space for screw fixing cannot be sufficiently provided. Also in view of screw shanks interfering with the optical components and the like, it is not possible to have a sufficient space for screw fixing. However, there are many problems in terms of reliability and service to assemble all components by stacking and bonding together without screwing.

In the case where the LED substrate is screwed to a side plate of a chassis, if a screw head comes between LEDs, the distance between the LEDs in that portion is made larger than the distance between the other LEDs. In order to avoid unevenness in light, dot patterns formed on the main surface are adjusted to correspond to the change in the distance so that the intensity of light directed from the main surface of the light guide plate is made uniform. The adjustment needs to be strict and is complicated, but a problem may be caused in long-term reliability if the components are assembled by bonding with double-sided tapes, not by screwing.

Furthermore, it is required for the liquid-crystal display apparatus to efficiently dissipate the heat generated from the LED substrate.

Japanese Patent Application Laid-Open No. 2009-180932 discloses the invention of a display apparatus configured to include a cylindrical boss on the back surface of a backlight chassis supporting a fluorescent tube, the cylindrical boss being fixed by screws to a heat sink provided at a rear cabinet, to conduct heat generated at the fluorescent tube to the heat sink through the backlight chassis and cylindrical boss.

In the case of Japanese Patent Application Laid-Open No. 2009-180932, the heat sink, cylindrical boss and screws for fixing the heat sink are required, which causes a problem of increasing the number of components and also a problem of increasing the thickness of the display apparatus due to the cylindrical boss.

The present invention has been made in view of the circumstances described above, and aims to provide a display apparatus having a simple configuration in which a light emitting element mounting substrate can be securely fixed to a chassis and a frame can also be securely fixed to the chassis, thereby realizing reduction in the thickness and border width of the apparatus, and also allowing the heat from the light emitting element mounting substrate to preferably dissipate without the need for changing the distance between light emitting elements, and to a TV receiver including the display apparatus.

### Means for Solving Problems

A display apparatus according to the present invention including: a display panel having a front surface on which an image is displayed; an optical sheet placed on a rear surface side of the display panel, for diffusing light and making the light enter the display panel; a holding body for holding the rear surface and a side surface of the display panel and forms a shape of a box; a positioning member having a side plate part interposed between a side surface of the optical sheet and the side surface of the holding body; and a front plate part being in parallel with a surface of the display panel, and performing positioning of the optical sheet in a plane direction, is characterized in that a convex part for positioning, protruding in a plane direction, is formed at a marginal part of the optical sheet, and a cutout into which the convex part is loosely inserted is formed at the front plate part.

According to the present invention, since a convex part for positioning is formed to protrude in a plane direction at a marginal part of the optical sheet and a cutout into which the convex part is loosely inserted is formed at the front plate part, it is possible to determine the position of an optical sheet by loosely inserting the convex part formed on the optical sheet into the cutout formed at the front plate part, allowing for positioning of the optical sheet.

The display apparatus according to the present invention is characterized in that the optical sheet has a rectangular shape in a plan view, and the convex part is formed on each of two opposing sides at the marginal part of the optical sheet.

According to the present invention, convex parts are formed respectively on opposing two sides at the marginal part of the optical sheet, which makes it possible to regulate the movement of the optical sheet in a plane direction substantially perpendicular to the line connecting the two convex parts.

The display apparatus according to the present invention is characterized in that the convex part is additionally formed at any one of the other two sides of the marginal part of the optical sheet.

According to the present invention, an additional convex part is further formed on either one of the other two sides of the marginal part of the optical sheet, which makes it possible to regulate the movement of the optical sheet in a plane direction substantially perpendicular to the protruding direction of the convex part.

The display apparatus according to the present invention is characterized by including: a light emitting element for supplying light to the display panel; and a light guide plate receiving light entering from the light emitting element at a side surface of the light guide plate, and outputting the light in a direction of the rear surface of the display panel to irradiate the display panel, and is characterized in that the light guide plate is placed between the display panel and the optical sheet, a fitting convex part is formed at an outer circumference of the light guide plate, and a fitting concave part is formed at the side plate part, which is fitted with the fitting convex part to determine a position of the light guide plate.

According to the present invention, a convex part for fitting (hereinafter also referred to as fitting convex part) is formed at an outer circumferential part of the light guide plate, while a concave part for fitting (hereinafter also referred to as fitting concave part) to be fitted with the fitting convex part is formed at a side plate part, so that the positioning of the light guide plate is performed by the fitting convex part being fitted with the fitting concave part.

The display apparatus according to the present invention is characterized in that the positioning member is configured to cover a front surface and a side surface of the light guide plate, and to shield light leaking from the light guide plate.

According to the present invention, the positioning member is configured to cover the front surface and the side surfaces of the light guide plate, so as to shield the light leaking from the light guide plate.

A television receiver according to the present invention is characterized by comprising a display apparatus according to any one of the examples described above and a reception part receiving television broadcasts, and is characterized in that a video image is displayed on the display apparatus based on the television broadcasts received by the reception part.

A liquid-crystal display apparatus according to the present invention, including a light guide plate located on a back surface of a liquid-crystal panel, a light source substrate placed on a side surface side of the light guide plate, a housing in which the light guide plate and light source substrate are accommodated, and an exterior component covering a front surface peripheral part of the liquid-crystal panel and a back surface of the housing, is characterized by further including a light-shielding member interposed between the housing and the exterior component to shield light leaking from the light source or the light guide plate to an outside, and is characterized in that the light-shielding member has a contact surface being in contact with the exterior component, and a recess is formed at the contact surface.

The liquid-crystal display apparatus according to the present invention is characterized in that the contact surface of the light-shielding member has a shape of a comb or a grid.

The liquid-crystal display apparatus according to the present invention is characterized in that the housing has a back surface part covering the back surface of the light guide plate, and a circumferential wall part provided at a circumference of the back surface part, the light source substrate is accommodated in the housing while being in contact with an inside of the circumferential wall part, the light-shielding member has a first portion being in contact with an outside of the circumferential wall part, and a second portion provided to be bent or curved with respect to the first portion and being in contact with the front surface peripheral part of the light guide plate, and a side of the first portion opposite to the side being contact with the circumferential wall part is configured as a contact surface to be in contact with the exterior component.

The liquid-crystal display apparatus according to the present invention is characterized in that the light-shielding member has a thermal conductivity smaller than thermal conductivities of the housing and the exterior component.

The liquid-crystal display apparatus according to the present invention is characterized in that the light-shielding member is an integrally-molded part made of synthetic resin, and the housing and the exterior component are made of metal.

Furthermore, the television receiver includes a tuner part receiving television broadcasts and the liquid-crystal display apparatus as described above, and is characterized in that the image concerning the television broadcasts received by the tuner part is displayed on the liquid-crystal panel of the liquid-crystal display apparatus.

According to the present invention, a light guide plate is placed on the back surface of a liquid-crystal panel, a light source substrate is placed on the side of a side surface of a light guide plate, the light guide plate and light source substrate are accommodated in a housing, and the liquid-crystal panel and housing are covered by an exterior component constituting a casing and the like of the liquid-crystal display apparatus. This corresponds to the configuration of a liquid-crystal display apparatus of the edge-light type. In this configuration, the liquid-crystal display apparatus includes a light shielding member interposed between the housing and exterior component, and shields the light leaking from the light source or light guide plate to the outside.

The heat transmitted from the light source substrate to the housing is further transferred from the housing to the light shielding member, and from the light shielding member to the exterior component. Here, at the light shielding member, a recess is formed on a contact surface which is in contact with the exterior component. The recess reduces the area of the contact surface, which can reduce the heat transferred from the light shielding member to the exterior component. By appropriately setting the size of the recess and the like, the contact area between the light shielding member and exterior component as well as the amount of heat transferred from the light shielding member to the exterior component can be adjusted as appropriate.

Moreover, according to the present invention, a recess is formed such that the contact surface between the light shielding member and the exterior component is made in a comb or grid shape. For example, in the case where the light shielding member is manufactured by integrally molding synthetic resin, a mold is used into which the synthetic resin is poured in the manufacturing. By a process of, for example, scraping away a projection in a mold corresponding to the recess of the shielding member, the area of the contact surface of the light shielding member can be adjusted. Such an adjustment process may easily be performed in a mold with a contact surface formed in a comb or grid shape.

Furthermore, according to the present invention, a light source substrate is accommodated in a housing having a back surface part and circumferential wall part while being in contact with the inside of the circumferential wall part. The light shielding member has a configuration having a first portion which is in contact with the outside of the circumferential wall part of the housing and a second portion provided in a bent or curved manner with respect to the first portion. The first portion of the light shielding member has a contact surface which is in contact with the exterior component at the opposite side of the side to be in contact with the housing, and a recess as described above is formed thereat. The second portion of the light shielding member is in contact with the peripheral part of the light guide plate to shield light leaking from a gap between the light guide plate and housing.

By such a configuration as described above, the amount of heat dissipation to the side of a side surface of the liquid-crystal display apparatus can appropriately be adjusted.

Furthermore, according to the present invention, the light shielding member is constituted by a material with a thermal conductivity smaller than thermal conductivities of the housing and exterior component. For example, the light shielding member may be formed as an integrally-molded component made of synthetic resin, while the housing and exterior component may be made of metal. Reduction in the thermal conductivity of the light shielding member allows the contact surface of the light shielding member with the exterior component to be wider.

A liquid-crystal display apparatus according to the present invention, including one or more optical sheets arranged on a back surface of a liquid-crystal panel, a light guide plate placed on a back surface of the optical sheet, a light source substrate placed on a side surface side of the light guide plate, a housing in which the light guide plate and light source substrate are accommodated, and an exterior component covering a front surface peripheral part of the liquid-crystal panel and a back surface of the housing, is characterized in that the housing has a back surface part covering a back surface of the light guide plate and a circumferential wall part formed at a circumference of the back surface part, the liquid-crystal display apparatus further comprises a light-shielding member being in contact with the front surface peripheral part of the light guide plate and the circumferential wall part of the housing, and shielding light leaking from the light source or light guide plate to an outside, the exterior component is configured to tuck in the liquid crystal panel and the housing, and attachment of the exterior component causes the light-shielding member to press the light guide plate to a back surface side.

Moreover, the liquid-crystal display apparatus according to the present invention is characterized in that the light-shielding member includes a panel contact surface being in contact with a back surface peripheral part of the liquid-crystal panel, and a positioning protrusion for determining a position of the liquid-crystal panel with respect to a direction along the panel contact surface.

Furthermore, the liquid-crystal display apparatus according to the present invention is characterized in that the panel contact surface is a flat surface, and an inclined surface is formed at the positioning protrusion.

Furthermore, the liquid-crystal display apparatus according to the present invention is characterized in that the circumferential wall part has a quadrangular frame shape, the light source substrate is accommodated in the housing while being in contact with an inside of one side of the circumferential wall part, and the light-shielding member is configured to be in contact with an outer surface of the circumferential wall part at one side, and to be in contact with an inner surface of the circumferential wall part at another side.

Furthermore, the liquid-crystal display apparatus according to the present invention is characterized in that the liquid-shielding member has a frame shape, the optical sheet is located inside the light-shielding member, and the liquid-crystal display apparatus comprises: one or more extension parts provided to extend from the optical sheet; and one or more positioning concave parts formed at the light-shielding member and determining a position of the optical sheet by accommodating the extension part or extension parts.

Moreover, a television receiver is characterized by including a tuner part for receiving television broadcasts and the liquid-crystal display apparatus as described above, and in that the image concerning the television broadcasts received by the tuner part is displayed on the liquid-crystal panel of the liquid-crystal display apparatus.

According to the present invention, an optical sheet is placed on the back surface of the liquid-crystal panel, and a light guide plate is placed on the back surface of the optical sheet. That is, the liquid-crystal panel, optical sheet and light guide plate are layered in this order. Moreover, a light source substrate is placed on the side of a side surface of the light guide plate, the light guide plate and light source substrate are accommodated in the housing, and the liquid-crystal panel and the housing are covered by an exterior component for constituting a casing or the like of the liquid-crystal display apparatus. This corresponds to the configuration of a liquid-crystal display apparatus of a so-called edge light type. In the liquid-crystal display apparatus with this configuration, a light-shielding member which is in contact with the front peripheral part of the light guide plate and the circumferential wall part of the housing shields the light leaking from the light source or light guide plate to the outside.

Furthermore, the exterior component is configured to be attached to sandwich the liquid-crystal panel and housing, the attachment of the exterior component making the light shielding member press the light guide plate to the back surface side. This can firmly fix the light guide plate and can prevent it from being out of position.

Furthermore, according to the present invention, the light shielding member has a panel contact surface which is in contact with the back surface peripheral part of the liquid-crystal panel. The light shielding member is configured to be in contact with the front surface peripheral part of the light guide plate and the back surface peripheral part of the liquid-crystal panel, i.e., is configured to be interposed between the light guide plate and the liquid-crystal panel. Moreover, the light-shielding member is provided with a positioning protrusion for defining the position of contact for the liquid-crystal panel with respect to the panel contact surface. Accordingly, the positioning of the liquid-crystal panel can be facilitated and be highly accurate.

Furthermore, according to the present invention, the panel contact surface of the light-shielding member is formed as a flat surface, while an inclined surface is formed for the positioning protrusion. By moving the liquid-crystal panel toward the panel contact surface along the inclined surface, positioning thereof can be performed.

Furthermore, according to the present invention, the housing has a back surface part of a substantially rectangular shape and a circumferential wall part of a quadrangular frame shape. The light source substrate is in contact with the inside of one side of the circumferential wall part corresponding to the lower side when the liquid-crystal display apparatus is installed, and is accommodated in the housing. The light-shielding member is configured to be in contact with the outside of the circumferential wall part on one side thereof where the light source substrate is located, and to be in contact with the inside of the circumferential wall part on another side thereof. Accordingly, the light emitted from the light source mounted on the light source substrate can be shielded by the shielding member so as not to leak to the outside. Moreover, a side not provided with the light source substrate can be narrowed in its border width. It is to be noted that the light shielding member may be one component which is integrally molded, or may be constituted by, for example, multiple components divided for the respective sides.

Furthermore, according to the present invention, the light shielding member and optical sheet are both arranged on the front surface side of the light guide plate. Thus, the light shielding member is made in a frame shape to be in contact with the front surface peripheral part of the light guide plate while an optical sheet is arranged inside the light shielding member. In this configuration, the optical sheet is provided with one or more extension parts, and the light shielding member is provided with a positioning concave part for accommodating the extension part to define the position of the optical sheet. This can facilitate the positioning of the optical sheet in, for example, assembly of the liquid-crystal display apparatus.

A display apparatus according to the present invention is characterized by including a display panel with a front side on which an image is displayed, a rectangular substrate on which a light emitting element is mounted, a light guide plate located at the rear side of the display panel, for outputting light entering a side surface opposed to the light emission element in a rear surface direction of the display panel to irradiate the display panel, a holding body for holding a peripheral part of the light guide plate, a fixing member for fixing the light guide plate to the holding body, and is characterized in that a positioning member, protruding toward the light guide plate, for positioning the light guide plate with respect to the light emitting element is located at an end in a longitudinal direction of the light emitting element mounting surface of the rectangular substrate, and that an end surface opposed to the light emitting element of the light guide plate is configured to be in contact with a tip end surface of the positioning member.

According to the present invention, a convex part is formed on one surface of the end part of a strip-shaped substrate to which a light emitting element is attached, and the positioning of the light guide plate is performed such that an end of the side surface opposed to the light emitting element of the light guide plate is in contact with the convex part. It is, therefore, possible to easily fix the substrate to the light guide plate while maintaining a predetermined distance between the side surface and the light emitting element.

The display apparatus according to the present invention is characterized in that the positioning member is adhered to the rectangular substrate with a double-sided tape.

According to the present invention, a convex part of a rectangular parallelepiped shape is adhered to the substrate with a double-sided tape, which makes it easy to provide the convex part.

The display apparatus according to the present invention is characterized in that the positioning member is formed with resin.

According to the present invention, the positioning member is made of resin, which makes it possible to easily mold the positioning member and also change the shape thereof.

The display apparatus according to the present invention is characterized in that the positioning member is an electronic component and is mounted on the rectangular substrate.

According to the present invention, the positioning member is formed by an electronic component, which can be mounted on a rectangular substrate by a mounting machine, allowing for precise mounting of the positioning member to the rectangular substrate.

The display apparatus according to the present invention is characterized in that the light emitting element is an LED.

According to the present invention, the light emitting element is an LED, which makes it possible to obtain light of high luminance with less power compared to the conventional cold-cathode tube.

The television receiver according to the present invention is characterized by including the display apparatus according to any one of the descriptions above and a reception part receiving television broadcasts, and in that a video image is displayed on the display apparatus based on the television broadcasts received by the reception part.

A display apparatus according to the present invention, including: a display panel with a front surface on which an image is displayed; a light guide plate located on a rear surface side of the display panel, for outputting light entering a side surface opposed to a light emitting element to the rear surface side of the display panel to irradiate the display panel; a holding body for holding a rear surface and a circumferential surface of the light guide plate; a fixing member covering a front surface peripheral part of the light guide plate, for fixing the light guide plate to the holding body and being in contact with a part of a rear surface peripheral part of the display panel; and a frame body covering a front surface peripheral part of the display panel, is characterized in that the fixing member has a plate-like part covering a front side peripheral part of the light guide plate, the plate-like part includes a periphery touching part being in contact with a rear surface peripheral part of the display panel, and a frame body contact part continuing to the periphery touching part, substantially flush with the front surface of the display panel and being in contact with the frame body, the display panel circumferential surface is separated from the frame body contact part, a groove is formed by a side surface of the frame body contact part, a portion of the periphery touching part and a circumferential surface of the display panel, and the frame body is provided with a convex part to be fitted into the groove to prevent the display panel from being out of position in a plane direction.

According to the present invention, the side surface of the frame contact part, a portion of the peripheral part contact part and a circumferential surface of the display panel form a groove, while the frame is provided with a positional shift preventing convex part to be fitted into the groove to prevent the display panel from being out of position in the plane direction. It is, therefore, possible to prevent the display panel from being out of position.

The display apparatus according to the present invention is characterized in that the convex part is configured to protrude in a direction of the front surface of the display panel.

The display apparatus according to the present invention is characterized in that the frame body contact part is provided with a projection extending in a direction of the circumferential surface of the display panel, and a tip end of the projection is chamfered.

According to the present invention, the projection extending in the circumferential direction of the display panel, which is provided at the frame contact part, has a chamfered tip end, making it possible to easily position the display panel when being placed on the frame.

A television receiver according to the present invention is characterized by including the display apparatus as described in any one of the above statements, and a reception part for receiving television broadcasts, and is characterized in that a video image is displayed on the display apparatus based on the television broadcasts received by the reception part.

A display apparatus according to the present invention, including a substrate on which a plurality of light emitting elements are mounted, a box having a side plate to which the substrate is attached, a display panel irradiated with light emitted from the light emitting element, and a frame covering a portion of the box including the side plate and an edge of the display panel, is characterized in that the substrate and a portion of the frame opposed to the side plate are screwed together with the side plate of the box interposed in between.

According to the present invention, the light emitting element mounting substrate and a portion opposed to the side plate of the frame are screwed with each other through a side plate of a box, which can facilitate simultaneous fixing of the substrate and frame to the box. As the substrate is being connected to the frame, the heat dissipation efficiency is increased compared to the display apparatus disclosed in Japanese Patent Application Laid-Open No. 2009-180932 in which the backlight chassis is connected to the heat sink attached to the frame. There is no increase in the number of components and no need for a boss, which can reduce the space for fixing the frame to the box, thereby realizing reduction in the thickness and border width of the display apparatus.

The display apparatus according to the present invention is characterized in that the substrate is provided with a female thread.

According to the present invention, since a female thread is provided at the substrate, the screw does not interfere the space between the light emitting elements on the substrate, unlike the case where a screw head is placed on the substrate, which can make the intervals of the light emitting elements uniform without the need for adjusting a dot pattern or the like on the light guide plate.

The display apparatus according to the present invention is characterized in that a light guide plate receiving light from the light emitting element entering from a side surface and outputting the light from a main surface is accommodated in the box, the display panel is placed in a vertical posture, being opposed to the main surface, and the frame is configured to cover a part of a bottom plate of the box and a lower edge of the display panel.

According to the present invention, the frame is formed in a U shape, which covers the front surface lower end, bottom surface and back surface lower end of the display module including the box at once, making it possible to progress reduction in thickness and border width.

The display apparatus according to the present invention is characterized by including a holding body sandwiching an edge of the light guide plate with the bottom plate and covering the side plate, and is characterized in that the substrate and a portion of the frame opposed to the side plate are screwed together through the holding body and the side plate.

According to the present invention, the light guide plate is held by the holding body and the light emitted from the substrate is shielded from being directed toward the frame side, while the amount of heat dissipation from the substrate to the frame can be adjusted by interposing the holding body between the substrate and the frame.

A television receiver according to the present invention is characterized by including the display apparatus as described above, and a reception part receiving television broadcasts, and is characterized in that a video image is displayed on the display apparatus based on the television broadcasts received by the reception part.

According to the present invention, the display apparatus as described above is provided to attempt reduction in the thickness and border width thereof.

In the display apparatus according to the present invention, the substrate and frame may be formed by the same material.

In this case, distortion will not occur due to thermal expansion.

An example of the material includes an aluminum.

### Effect of the Invention

According to the present invention, it is possible to precisely position the light guide plate, optical sheet and the like, and to fix them to the backlight chassis without a molding process or screwing.

According to the present invention, in a light shielding member interposed between a housing and an exterior component, a recess is formed at a contact surface thereof, which can reduce the heat transferred from the light shielding member to the exterior component. By appropriately setting the size and the like of the recess, the amount of heat transferred from the light shielding member to the exterior component can be adjusted. Therefore, the liquid-crystal display apparatus can appropriately dissipate the heat generated from the light source to the outside and can also suppress a temperature rise at a portion which may be touched by the user.

According to the present invention, a liquid-crystal display apparatus of the edge light type is configured in which a liquid-crystal panel, an optical sheet and a light guide plate are layered, a light source substrate is placed on the side of a side surface of the light guide plate, which are accommodated in a housing. Moreover, a light shielding member is provided which is in contact with the front surface peripheral part of the light guide plate and the circumferential wall part of the housing, and the light leaking from the light source or light guide plate to the outside is shielded by the light shielding member. This can realize the reduction in thickness and border width of the liquid-crystal display apparatus, and can prevent the light from the light source, light guide plate or the like from leaking to the outside.

According to the present invention, it is possible to easily fix the light guide plate to the backlight chassis while maintaining a predetermined distance between the side surface of the light guide plate and the light emitting element.

According to the present invention, the side surface of the frame body contact part, a part of the periphery touching part and the circumferential surface of the display panel form a groove, while a convex part to be fitted into the groove to prevent the display panel from being out of position in the plane direction, making it possible to prevent the display panel from being out of position.

According to the present invention, the light emitting element mounting substrate is screwed with the portion opposed to the side plate of the frame, making it possible to easily and simultaneously fix the substrate as well as the frame to the box. The substrate is being connected to the frame, which makes the heat dissipation efficiency preferable. There is no increase in the number of components and no need for a boss, which can reduce the space for fixing the frame to the box, thereby realizing reduction in the thickness and border width of the display apparatus.

### BRIEF DESCRIPTION OF THE DRAWINGS

FIG. 1 is a perspective view of an outer appearance of a television receiver;

FIG. 2 is an exploded perspective view of a main part of the television receiver;

FIG. 3 is a partial exploded perspective view of a main part of the television receiver;

FIG. 4 is a partial exploded perspective view of a right side holder of an optical member holder;

FIG. 5 is a partial exploded perspective view of a right side holder of an optical member holder;

FIG. 6 is a perspective view illustrating the state where a light guide plate and an optical sheet are layered;

FIG. 7 is a perspective view illustrating the state where the right side holder is attached to a backlight chassis;

FIG. 8 is a partial perspective view of the backlight chassis and optical member folder;

FIG. 9 is a partial perspective view taken along the line IX-IX in FIG. 1;

FIG. 10 is an exploded perspective view illustrating a configuration of a liquid-crystal display apparatus according to an embodiment of the present invention;

FIG. 11 is a partial enlarged section view illustrating a configuration of a liquid-crystal display apparatus according to an embodiment of the present invention;

FIG. 12 is a perspective view illustrating a configuration of a light shielding member;

FIG. 13 is a partial enlarged perspective view of the light shielding member;

FIG. 14A is a schematic view illustrating a modification of a contact surface of the light shielding member;

FIG. 14B is a schematic view illustrating a modification of a contact surface of the light shielding member;

FIG. 15 is a block diagram illustrating a configuration of a television receiver according to a modification;

FIG. 16 is an exploded perspective view illustrating a configuration of a liquid-crystal display apparatus according to an embodiment of the present invention;

FIG. 17 is a partial enlarged section view illustrating a configuration of a liquid-crystal display apparatus according to an embodiment of the present invention;

FIG. 18 is a partial enlarged section view illustrating a configuration of a liquid-crystal display apparatus according to an embodiment of the present invention;

FIG. 19 is an enlarged perspective view illustrating configurations of an optical sheet and a light shielding member;

FIG. 20 is a block diagram illustrating a configuration of a television receiver according to a modification;

FIG. 21 is a perspective view of an outer appearance of a television receiver;

FIG. 22 is an exploded perspective view of a main part of the television receiver;

FIG. 23 is a plan view of an LED substrate;

FIG. 24 is a perspective view illustrating a manner in which the LED substrate is attached;

FIG. 25 is a plan view illustrating a manner of a light guide plate positioned by a spacer;

FIG. 26 is a partial perspective view for illustrating a method of fixing the light guide plate;

FIG. 27 is a plan view illustrating a manner of the light guide plate positioned by a lower convex part formed on the light guide plate;

FIG. 28 is a perspective view of an outer appearance of a television receiver;

FIG. 29 is an exploded perspective view of a main part of the television receiver;

FIG. 30 is a partial perspective view of a lower side holder;

FIG. 31 is a partial perspective view of a liquid-crystal panel;

FIG. 32 is a partial perspective view illustrating the state where a liquid-crystal panel is placed on an optical member holder;

FIG. 33 is a partial perspective view along the line in FIG. 28;

FIG. 34 is a partial perspective view along the line VII-VII in FIG. 28;

FIG. 35 is a perspective view illustrating a TV receiver according to an embodiment of the present invention;

FIG. 36 is an enlarged perspective view illustrating a portion excluding a stand of the TV receiver according to an embodiment of the present invention;

FIG. 37 is a back surface view illustrating the TV receiver according to an embodiment of the present invention;

FIG. 38 is a partial side surface view illustrating the TV receiver according to an embodiment of the present invention when viewed from the left side;

FIG. 39 is a partial section view illustrating the TV receiver according to an embodiment of the present invention when viewed from the left side;

FIG. 40 is a plan view illustrating an LED substrate according to an embodiment of the present invention; and

FIG. 41 is an exploded perspective view illustrating a display apparatus according to an embodiment of the present invention.

### BEST MODE FOR CARRYING OUT THE INVENTION

### Embodiment 1

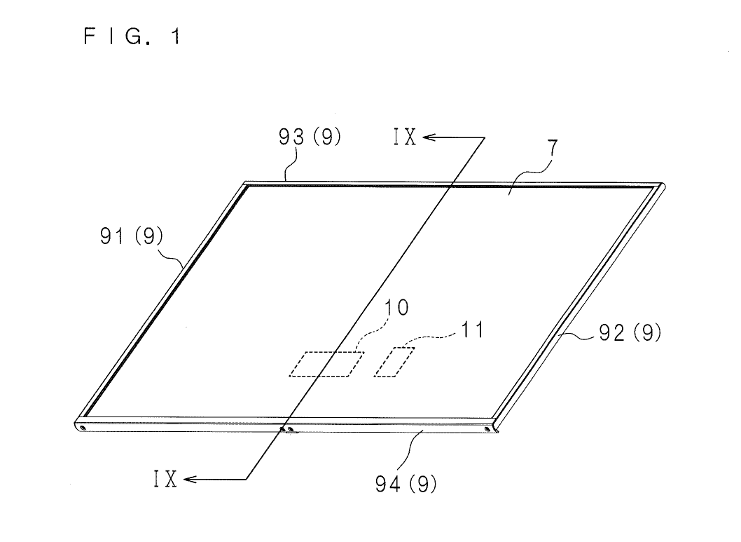

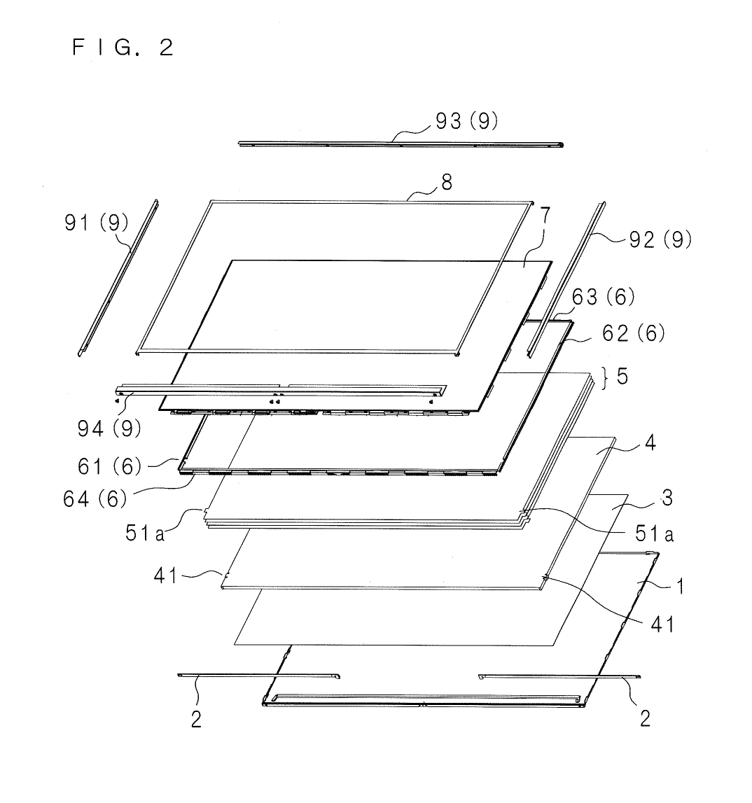

A display apparatus according to an embodiment of the present invention will be described below by taking a television receiver as an example. FIG. 1 is a perspective view of an outer appearance of a television receiver. FIG. 2 is an exploded perspective view of a main part of the television receiver. The television receiver includes a backlight chassis 1 (holding body), an LED (Light Emitting Diode) substrate 2, a reflection sheet 3, a light guide plate 4, an optical sheet 5, an optical member holder 6 (positioning member), a liquid-crystal panel 7 (display panel), a panel cover 8, a frame 9, a tuner board 10 and a power supply board 11.

In the description below, the side of the television receiver on which the liquid-crystal panel 7 is located will be referred to as a front side, or simply “front.” The opposite side of the front side will be referred to as a rear side or simply “rear.” The left of the liquid-crystal panel 7 as shown in the drawing will be referred to as a left side or simply “left.” The right of the liquid-crystal panel 7 as shown in the drawing will be referred to as a right side or simply “right.” In the case where the television receiver stands vertically, the upper direction thereof will be referred to as an upper side or simply “top.” Likewise, the lower direction of the liquid-crystal panel 7 will be referred to as a lower side or simply “bottom.”

Moreover, unless specifically described, each component of the television receiver will be described in the state of being assembled in the television receiver.

The backlight chassis 1 has the shape of a shallow box with one surface thereof being open. The backlight chassis 1 is to be a part of a casing of the television receiver. In order to ensure the strength, the backlight chassis 1 is formed with metal, for example, a steel plate. The backlight chassis 1 is molded by press molding. As long as the strength is ensured, the backlight chassis 1 may be formed with a light metal such as an aluminum.

The LED substrate 2 has the shape of a rectangular flat plate, which is a long and narrow substrate (rectangular substrate). An LED is mounted on the LED substrate 2 as a light-emitting element. In order to efficiently dissipate the heat generated by the LED, the LED substrate is formed with an aluminum. The LED substrate 2 includes two symmetric pieces.

The light guide plate 4 has the shape of a rectangular plate which is a little smaller than the backlight chassis 1. The light guide plate 4 is made of synthetic resin such as acrylic resin, polycarbonate resin, methacrylate resin, cyclic polyolefin or the like.

The reflection sheet 3 has substantially the same shape as the light guide plate 4 in the plan view. The reflection sheet 3 is a sheet made of synthetic resin. The reflection sheet 3 has a function of totally reflecting the incident light. The optical sheet 5 is comprised of multiple sheets. The multiple sheets constituting the optical sheet 5 include a diffusion sheet, a reflection/polarization sheet, a lens sheet and the like. The optical sheet 5 is a synthetic resin sheet. The optical sheet 5 is a laminated body in which the sheets as described above are laminated.

The optical member holder 6 has the shape of a frame. The optical member holder 6 is constituted by four bar-like members each having a substantially L-shaped cross section. The four bar-like members constituting the optical member holder 6 are a left side holder 61, a right side holder 62, an upper side holder 63 and a lower side holder 64. Each of the members constituting the optical member holder 6 is formed with engineering plastic such as polycarbonate, polyacetal or polyamide.

The liquid-crystal panel 7 has the shape of a substantially rectangular parallelepiped, which displays an image on the front side thereof. The panel cover 8 is member having the shape of a rectangular frame. The panel cover 8 covers the peripheral part of the liquid-crystal panel 7. The liquid-crystal panel 7 is fixed by the frame 9 through the panel cover 8.

The frame 9 is constituted by four long and narrow bar-like members each having a U-shaped cross section. The members constituting the frame 9 are a left frame 91, a right frame 92, an upper frame 93 and a lower frame 94. The left frame 91 covers the left side surface of the television receiver. The right frame 92 covers the right side surface of the television receiver. The upper frame 93 covers the upper side of the television receiver. The lower frame 94 covers the lower side of the television receiver. Each component of the television receiver is sandwiched and fixed between two opposing surfaces of the frames.

The tuner board 10 receives television broadcasts and takes out broadcast signals. Based on the broadcast signals taken out by the tuner board 10, an image is displayed on the liquid-crystal panel 7. The power supply board 11 supplies power of a predetermined voltage to each part of the television receiver. The tuner board 10 and power supply board 11 are fixed with screws to the outer rear surface of the backlight chassis 1. The tuner board 10 and the power supply board 11 fixed to the backlight chassis 1 are covered with a board cover (not illustrated) for protection.

The television receiver having a configuration as described above is assembled as follows. The LED substrate 2 is fixed to a plate-like portion extending from the rear side to the front side at the lower side of the backlight chassis 1. The reflection sheet 3 is placed on the box-like bottom plate portion of the backlight chassis 1. The light guide plate 4 is placed on the reflection sheet 3. The light guide plate 4 is so positioned as to maintain a predetermined distance between the end surface on the lower side thereof and an LED mounting surface of the LED substrate 2. The optical sheet 5 is placed on the light guide plate 4. The optical member holder 6 is fixed to the backlight chassis 1. By the optical member holder 6 being fixed, the light guide plate 4 is positioned and fixed. By the optical member holder 6 being fixed, the position of the optical sheet 5 is also determined.

The liquid-crystal panel 7 is placed on the optical sheet 5 and optical member holder 6. Moreover, the panel cover 8 covering the peripheral part of the liquid-crystal panel 7 is placed thereon. The frame 9 sandwiches and fixes the layered members from the backlight chassis 1 to panel cover 8.

In the television receiver configured as described above, the light emitted by the LED enters the light guide plate 4 from a side edge thereof. Since the reflection sheet 3 is located at the rear side of the light guide plate 4, the light travelling in the direction of the rear side of the light guide plate 4 is reflected by the reflection sheet 3. The light reflected by the reflection sheet 3 irradiates the liquid-crystal panel 7 from the rear side. The liquid-crystal panel 7 is controlled so as to display an image on the front side of the liquid-crystal panel 7.

The optical member holder 6 is responsible for three roles. The first role of the optical member holder 6 is to position the reflection sheet 3, light guide plate 4, optical sheet 5 and liquid-crystal panel 7. The second role of the optical member holder 6 is to fix the light guide plate 4. The third role of the optical member holder 6 is to shield the light of the LED leaking to the outside.

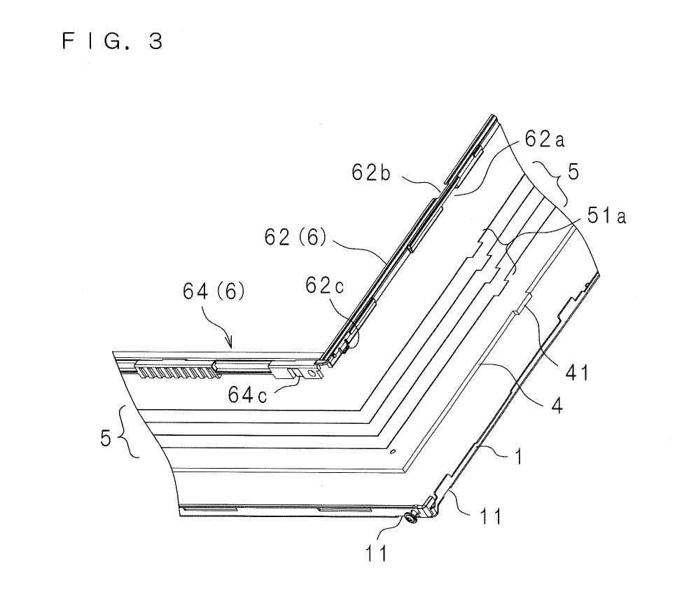

FIG. 3 is a partial exploded perspective view of a main part of the television receiver. The lower right corner of the television receiver is illustrated. To simplify the illustration, only the backlight chassis 1, light guide plate 4, optical sheet 5 and optical member holder 6 are shown. A reflection sheet (not illustrated), the light guide plate 4 and the optical sheet 5 are layered in this order on the backlight chassis 1.

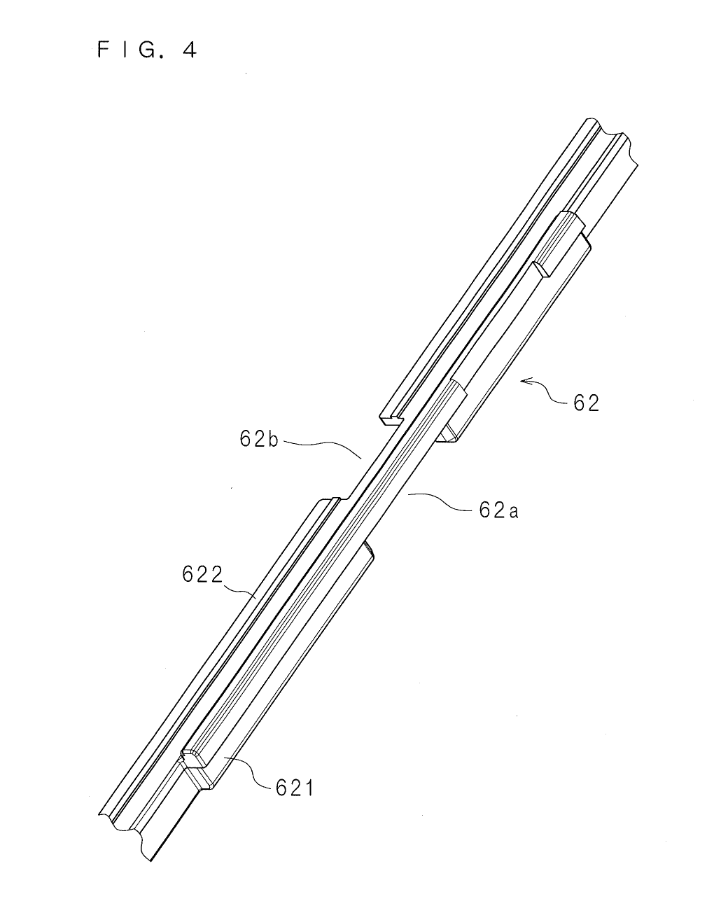

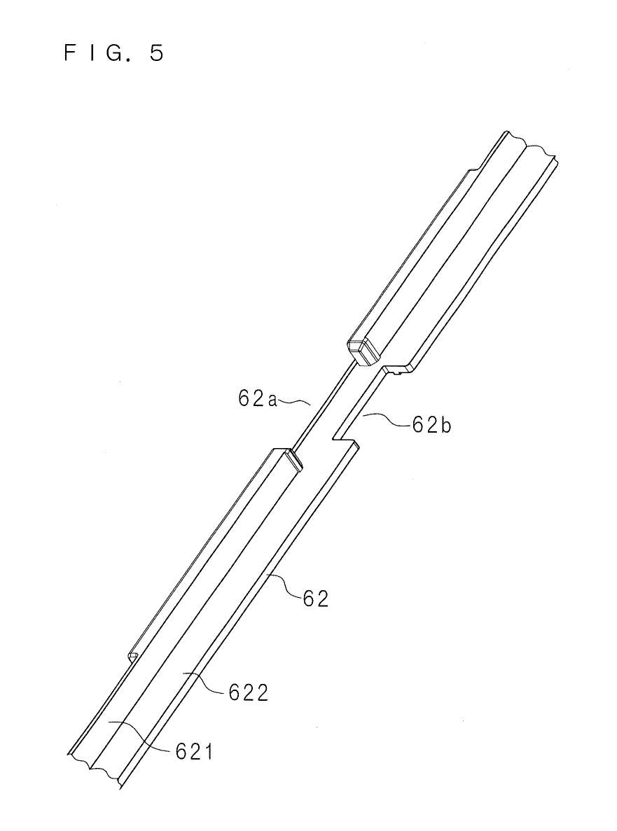

FIGS. 4 and 5 are partial exploded perspective views each illustrating the right side holder 62 of the optical member holder 6. FIG. 4 is an illustration viewed from the front side. FIG. 5 is an illustration viewed from the rear side. The right side holder 62 of the optical member holder 6 is a bar-like member having an L-shaped cross section. The right side holder 62 has a side plate part 621 which is in parallel with a side surface of the television receiver and which extends in the longitudinal direction, as well as a front plate part 622 which is in parallel with the display surface of the television receiver and which extends in the longitudinal direction. At the side plate part 621, a concave part 62a (fitting concave part) having the shape of a cut-out rectangle is formed. A concave part 62b (cutout) having the shape of a cut-out rectangle is similarly formed at the front plate part 622.

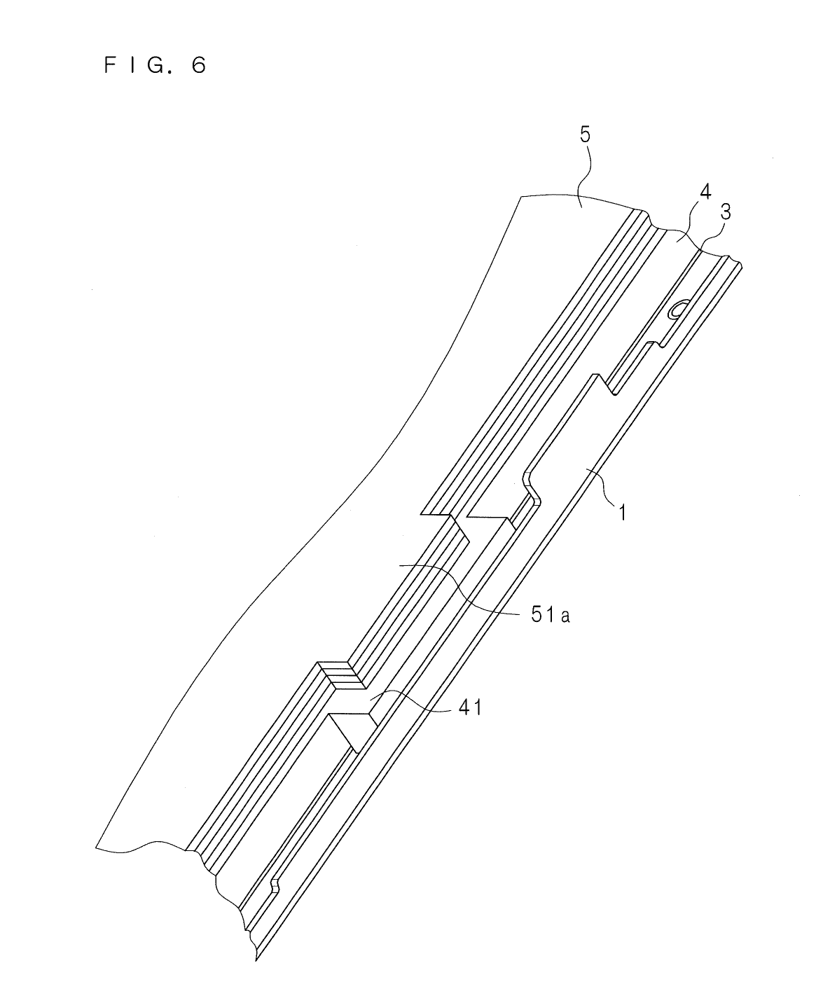

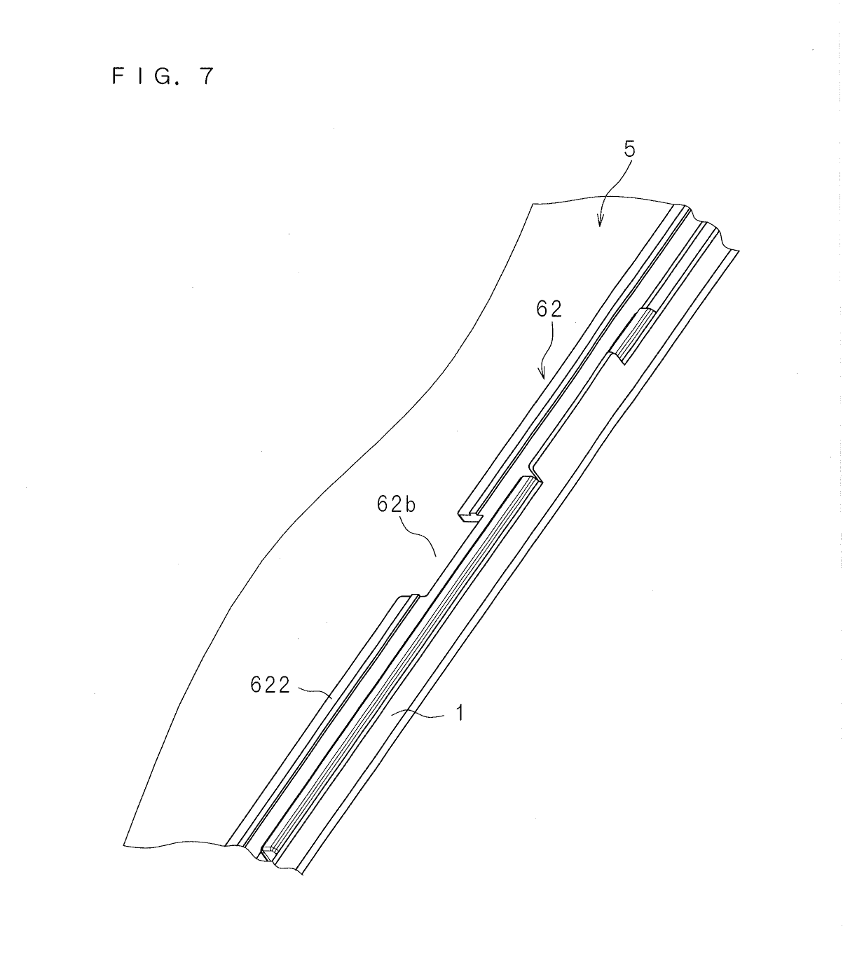

FIG. 6 is a perspective view illustrating the state where the light guide plate 4 and the optical sheet 5 are layered. The reflection sheet 3, light guide plate 4 and optical sheet 5 are layered in this order on the backlight chassis 1. FIG. 7 is a perspective view illustrating the state where the right side holder 62 is attached to the backlight chassis 1.

Fitting convex part 41 is formed at the outer circumferential part of the light guide plate 4. The fitting convex part 41 has the shape of a rectangular parallelepiped. The fitting convex part 41 is provided to protrude further than the side surface of the light guide plate 4. Two fitting convex parts 41 are formed at portions symmetrical to each other. The fitting convex part 41 is positioned slightly upper than the lower surface of the light guide plate 4 in the vertical direction.

A convex part 51a is formed at a marginal part of the optical sheet 5. The convex part 51a has a rectangular shape in a plan view. The convex part 51a is provided to protrude in the wide surface direction of the optical sheet 5. Two convex parts 51a are formed at positions symmetrical to each other. The convex part 51 is positioned slightly upper than the lower side of optical sheet 5 in the vertical direction.

The rectangle for the fitting convex part 41 of the light guide plate 4 in a plan view is made larger than the rectangle for the convex part 51a of the optical sheet 5 in a plan view. The fitting convex part 41 and the convex part 51a are so positioned as to be overlapped with each other when the optical sheet 5 is layered on the light guide plate 4.

When the right side holder 62 is fixed to the backlight chassis 1, the concave part 62a is fitted with the fitting convex part 41 formed at the light guide plate 4. This restricts the movement of the light guide plate 4 in the vertical direction by the concave part 62a of the right side holder 62. Moreover, the light guide plate 4 is pressed by the front plate part 622. A structure symmetrical to this structure is provided on the left side of the television receiver.

The convex part 51a of the optical sheet 5 is loosely inserted into the concave part 62b of the right side holder 62. This regulates the movement of the optical sheet 5 in the vertical direction by the concave part 62b of the right side holder 62. A structure symmetrical to this structure is provided on the left side of the television receiver. A similar structure is provided on the upper side of the television receiver, to regulate the movement of the optical sheet 5 in the horizontal direction.

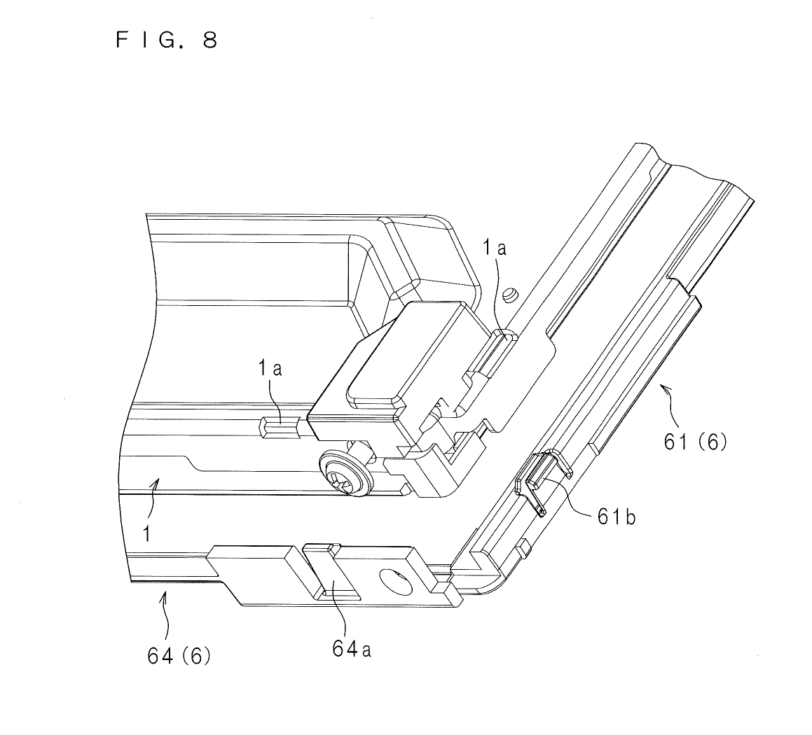

FIG. 8 is a partial perspective view of the backlight chassis 1 and the optical member folder 6. FIG. 8 is a view illustrating the left corner portion of the television receiver when viewed from the rear side. Engaging claws 61b are formed at several portions on the left side holder 61 of the optical member holder 6. Engaging claws 64a are formed at several portions on the lower side holder 64 of the optical member holder 6. Engaging claws similar to the engaging claws 61b are also formed at the right side holder 62 and the upper side holder 63. Holes 1a are formed at several portions of the bottom plate part of the backlight chassis 1. By the engaging claws 61b of the optical member holder 6 being engaged with the respective holes 1a from the inside of the backlight chassis 1, the optical member holder 6 is fixed to the backlight chassis 1. By the engaging claws 64a of the lower side holder 64 being engaged with the respective holes 1a from the outside of the backlight chassis 1, the lower side holder 64 is fixed to the backlight chassis 1.

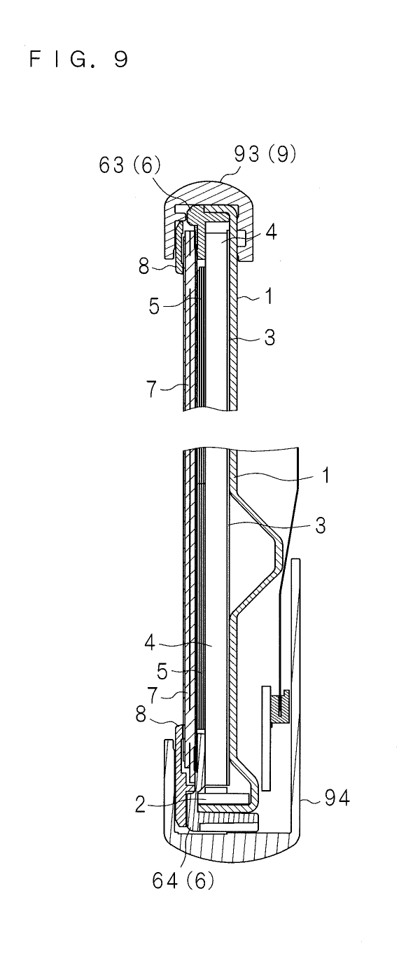

FIG. 9 is a partial perspective view taken along the line IX-IX in FIG. 1. FIG. 9 illustrates the cross sections of the upper side portion and the lower side portion of the television receiver, whereas the intermediate portion thereof is not illustrated.

As illustrated in the lower side section view in FIG. 9, one surface forming the substantially L-shaped cross section of the lower side holder 64 of the optical member holder 6 presses the light guide plate 4 from the front side to fix the light guide plate 4. The other surface forming the substantially L-shaped cross section of the lower side holder 64 is fitted to the outer surface at the upper part of the lower side plate of the backlight chassis 1.

As illustrated in the upper side cross section view in FIG. 9, one surface forming the substantially L-shaped cross section of the upper side holder 63 of the optical member holder 6 presses the light guide plate 4 from the front side to fix the light guide plate 4. The other surface forming the substantially L-shaped cross section of the upper side holder 63 comes between the upper plate-like part of the backlight chassis 1 and the light guide plate 4, and is fitted to the inner surface of the upper plate-like part of the backlight chassis 1.

The left side holder 61 of the optical member holder 6 fixes the left side peripheral part of the light guide plate 4. The right side holder 62 of the optical member holder 6 fixes the right side peripheral part of the light guide plate 4. The positional relationship between the left side holder 61 or right side holder 62 and the backlight chassis 1 is similar to that for the upper side holder 63.

As described above, by fixing the optical member holder 6 to the backlight chassis 1, the position of the light guide plate 4 in the vertical direction is determined while being fixed. Moreover, by fixing the optical member holder 6 to the backlight chassis 1, positioning of the optical sheet 5 is performed. It is possible to position and fix the light guide plate 4 and position the optical sheet 5 only by fitting the optical member holder 6 with the backlight chassis 1 without using a screw. This makes it possible to ensure higher accuracy in the less assembly man hours.

The optical member holder 6 covers the front side peripheral part (front surface) of the light guide plate 4. The optical member holder 6 covers the end surfaces on the right and left as well as the end surface on the upper side of the light guide plate 4. This allows the optical member holder 6 to shield the light of the LED leaking from the light guide plate 4.

The technical feature (components) described in the embodiments may be combined with one another, and may form a new technical feature by such a combination.

The embodiments disclosed herein are to be construed as illustrative and not limitative in all aspects. The scope of the invention is defined by the appended claims rather than by the description preceding them, and all changes that fall within metes and bounds of the claims, or equivalence of such metes and bounds thereof are therefore intended to be embraced by the claims.

### Embodiment 2

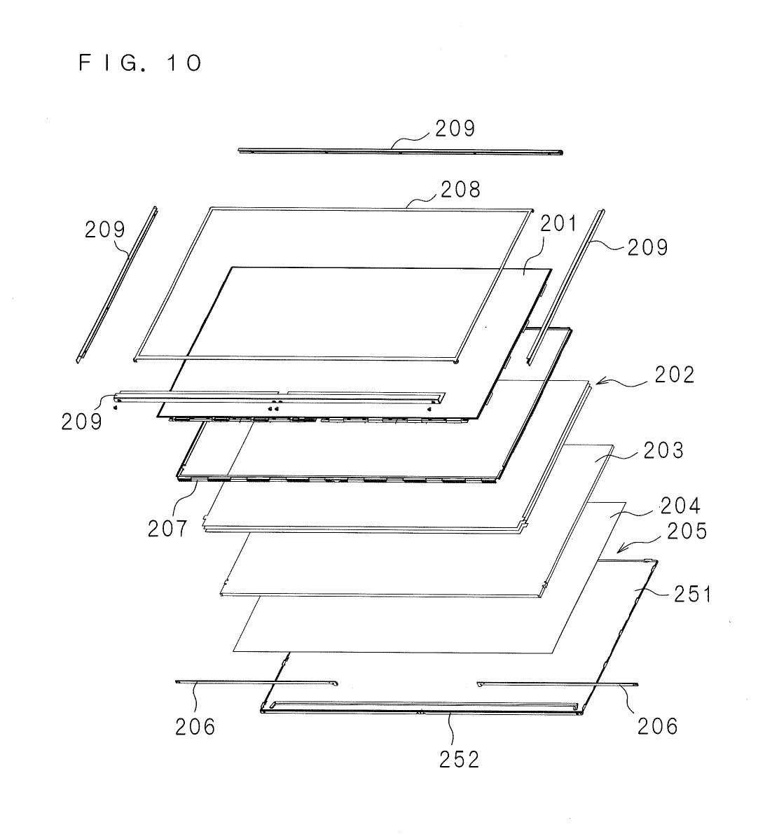

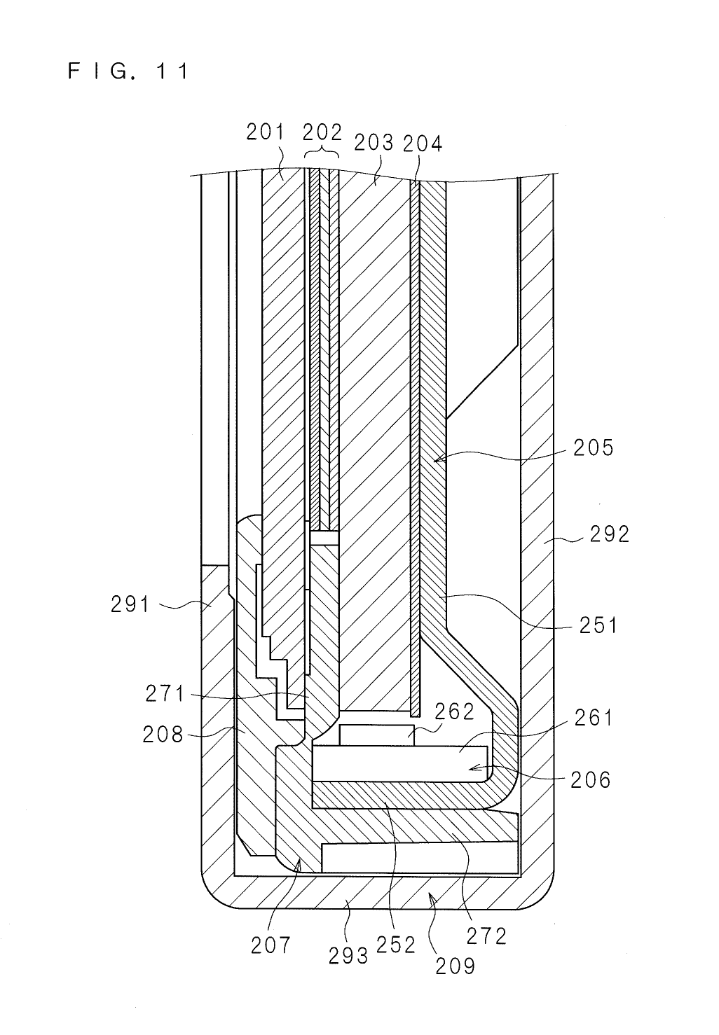

The present invention will specifically be described with reference to the drawings illustrating an embodiment thereof. FIG. 10 is an exploded perspective view illustrating a configuration of a liquid-crystal display apparatus according to the present embodiment. FIG. 11 is a partial enlarged section view illustrating a configuration of a liquid-crystal display apparatus according to the present embodiment. In FIGS. 10 and 11, the reference numeral 201 denotes a liquid-crystal panel. The liquid-crystal panel 201 is a device having the shape of a substantially rectangular plate and displaying an image by controlling the transmittance of the light irradiating from the back surface for each pixel. At the back surface side of the liquid-crystal panel 201, multiple optical sheets 202, a light guide plate 203 and a reflection pate 204 are layered. The optical sheets 202 is an optical member for diffusing light, for example, each sheet having a different optical characteristic. Each optical sheet 202 has a substantially rectangular shape of the same size as or somewhat smaller than the liquid-crystal panel 201, and the optical sheets 202 all have substantially the same shape.

The light guide plate 203 has a substantially rectangular plate shape of the same size as or somewhat larger than the liquid-crystal panel 201. The light guide plate 203 is an optical member reflecting and diffusing the light entering from a side surface thereof inside, and outputs the light from the front surface. Thus, the light guide plate 203 has a larger thickness and side surface area compared to the liquid-crystal panel 201, reflection plate 204 and the like. The reflection plate 204 has a substantially rectangular plate-like shape of the same size as or somewhat larger than the light guide plate 203. The reflection plate 204 is a member with a front surface being a mirror surface, and reflects the light output from the back surface of the light guide plate 203 into the light guide plate 203 and further onto the back surface of the liquid-crystal panel 201.

A metal chassis 205 is placed on the back surface of the reflection plate 204. The chassis 205 is a housing which forms the shape of a tray or a container having a substantially rectangular bottom surface 251 covering the back surface of the reflection plate 204 and a circumferential wall part 252 enclosing the bottom surface 251, and accommodates the layered optical sheet 202, light guide plate 203 and reflection plate 204. On the circumferential wall part 252 at the lower side (the side to be on the lower side in the state where the liquid-crystal display apparatus is installed for use) of the chassis 205, an LED substrate 206 is fixed. The LED substrate 206 includes a substrate part 261 formed in the shape of a long and narrow substantially rectangular plate on which multiple LEDs 262 are mounted side by side in the longitudinal direction. The LED substrate 206 is fixed being in contact with the inner surface of the circumferential wall part 252 of the chassis 205, while the LEDs 262 mounted thereon are opposed to the side surface of the light guide plate 203 in this state. Accordingly, the light emitted by the LED 262 enters the light guide plate 203 from the side surface thereof, and the back surface of the liquid-crystal panel 201 is irradiated with the light from the light guide plate 203.

In order to prevent the light of the LEDs 262 from leaking out of the gap between the side surface of the light guide plate 203 accommodated in the chassis and the circumferential wall part 252 of the chassis 205, the liquid-crystal display apparatus includes a light-shielding member 207. The light-shielding member 207 having a substantially rectangular frame-like shape is a member made of synthetic resin, each side thereof forming a substantially L-shaped section. The light-shielding member 207 is in contact with the front surface peripheral part of the light guide plate 203 accommodated in the chassis 205 while having a light-shielding part 271 blocking the gap between the light guide plate 203 and the circumferential wall part 252 of the chassis 205, as well as a heat dissipation part 272 provided in a manner of being bent or curved with respect to the light shielding part 271 and being in contact with the outer surface of the circumferential wall part 252 of the chassis 205. The light shielding part 271 of the light shielding member 207 is provided to be adjacent to the multiple optical sheets 202 at the front surface of the light guide plate 203, while being in contact with the back surface peripheral part of the liquid-crystal panel 201. It is noted that the detailed configuration of the light shielding member 207 will be described later.

The liquid-crystal display apparatus includes a panel cover 208 being in contact with the front surface peripheral part of the liquid-crystal panel 201, the panel cover 208 forming the shape of a substantially rectangular frame. Thus, the liquid-crystal panel 201 is fixed in such a manner that the peripheral part thereof is sandwiched between the light shielding part 271 of the light shielding member 207 and the panel cover 208.

Moreover, the liquid-crystal display apparatus includes a frame 209 for fixing the components from the liquid-crystal panel 201 to the reflection plate 204 and the like layered and accommodated in the chassis 205 as described above. The frame 209 is a metal part serving as an exterior of the liquid-crystal display apparatus. Four frames 209 are provided to correspond to the respective sides, i.e. upper, lower, left and right sides, of the liquid-crystal panel 201 and the like. Each frame 209 is a long and narrow member having a length corresponding to each side of the liquid-crystal panel 201 or the like, having a substantially U-shaped (or substantially J-shaped) cross section. The frame 209 has a front surface covering part 291 covering the front surface peripheral part of the liquid-crystal panel 201, a back surface covering part 292 covering the back surface peripheral part of the chassis 205, and a side surface covering part 293 connecting the front surface covering part 291 and back surface covering part 292 to cover the side surface of the chassis 205. In the frame 209, the front surface covering part 291 is in contact with the front surface of the panel cover 208, the side surface covering part 293 is in contact with the heat dissipation part 272 of the light shielding member, and the back surface covering part 292 is in contact with the back surface of the chassis 205 or the like. Furthermore, the frame 209 is screwed to the chassis 205 via a through hole or the like formed on the heat dissipation part 272 of the light shielding member 207. Thereby, the liquid-crystal panel 201, optical sheet 202, light guide plate 203, reflection plate 204, chassis 205, light shielding member 207, panel cover 208 and the like are fixed in such a manner that four sides are tucked in the frame 209.

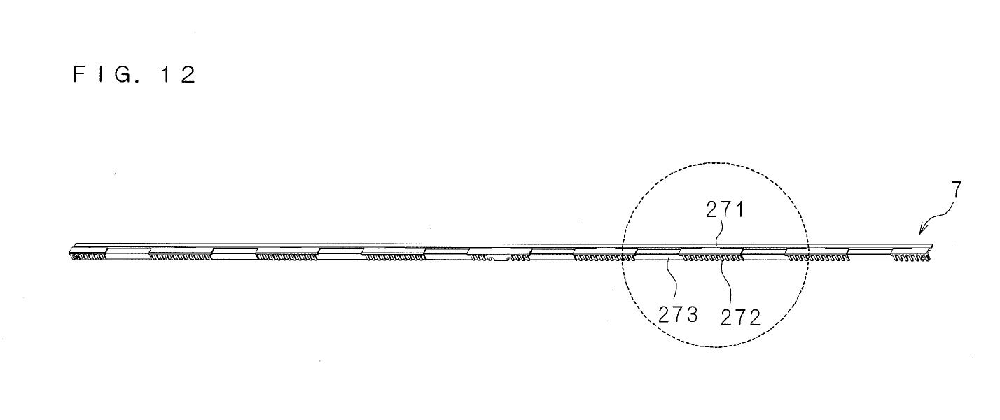

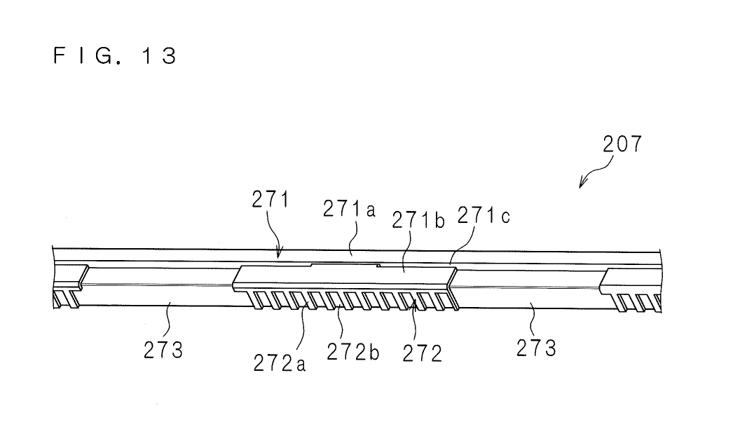

FIG. 12 is a perspective view illustrating a configuration of the light shielding member 207, a part corresponding to one side (lower side of the liquid-crystal display apparatus) of the frame-shaped light-shielding member 207 being extracted for illustration. FIG. 13 is a partial enlarged perspective view of the light shielding member 207, in which the portion enclosed by the broken line circle in FIG. 12 is enlarged. As described above, the light shielding member 207 is a long and narrow member including a light shielding part 271 being in contact with the light guide plate 203 and a heat dissipation part 272 being in contact with the circumferential wall part 252 of the chassis 205, the light shielding part 271 and the heat dissipation part 272 being bent or curved in a substantially L shape. Moreover, the light shielding part 271 of the light shielding member 207 includes a portion 271a being in contact with the light guide plate 203 and a portion 271b blocking a gap between the light guide plate 203 and the chassis 205, while a step 271c being formed between both portions 271a and 271b.

Furthermore, at the outer side (the side being in contact with the panel cover 208 and frame 209) of the light shielding member 207, more than one gaps 273 for a flexible printed board (not illustrated) to pass through are formed by reducing the thickness. The gaps 273 are formed at substantially equal intervals in the longitudinal direction of the light shielding member 207, the panel cover 208 and frame 209 not being in contact with the light shielding member 207 at the parts of the gaps 273. Thus, the light-shielding member 207 includes the portions being in contact with the panel cover 208 and frame 209, and the portions not being in contact therewith alternately arranged in the longitudinal direction. The flexible printed board passing through the gap 273 is connected at one end thereof to (the driving circuit or the like of) the liquid-crystal panel 201, and is connected at the other end thereof to a control circuit board or the like mounted on a concave part formed on the back surface of the chassis 205.

At the heat dissipation part 272 of the light shielding member 207, multiple rectangular recesses 272b which are elongated in the direction intersecting with the longitudinal direction of the light-shielding member 207 are formed on the contact surface 272a with the frame 209. Due to the recesses 272b, the contact surface 272a has a comb shape. The light-shielding member 207 is in contact with the frame 209 at the contact surface 272a of the comb shape, but is not in contact with the frame 209 at the recess 272b. Such a configuration can reduce the contact area between the light-shielding member 207 and the frame 209. Therefore, the heat generated by the emission of the LEDs 262 on the LED substrate 206 can reduce the amount of heat to be transferred to the frame 209 via the frame 209 and the light shielding member 207, which can suppress the increase in the temperature of the frame 209. It is also possible to adjust the amount of heat transferred from the light-shielding member 207 to the frame 209 by adjusting the dimension of the recess 272b and thus adjusting the area of the contact surface 272a.

The light shielding member 207 is fabricated by integral molding with synthetic resin such as plastic (or may also be molded by dividing the frame-like light shielding member 207 into four sides). Therefore, a metal mold (not illustrated) into which synthetic resin is poured is used in fabrication of the light-shielding member 207, while a protrusion corresponding to the recess 272b described above is formed on the metal mold. For example, a part or all of the protrusion on the metal mold may be scraped away so as to adjust the area of the contact surface 272a of the light-shielding member 207 to be molded. If the contact surface 272a has a comb shape, multiple rectangular protrusions are formed on the metal mold, which can easily be processed by scraping away or the like.

In the present embodiment, while the light-shielding member 207 is made of synthetic resin such as plastic, the chassis 205 and frame 209 are made of metal such as aluminum, iron or copper. The thermal conductivity of the light-shielding member 207 is lower than that of the chassis 205 or frame 209.

If, for example, the thermal conductivity of the frame 209 is low, diffusion of the heat transferred from the contact surface 272a of the light-shielding member 207 will be insufficient, which may cause a portion of the frame 209 to have a locally high temperature. Moreover, if the light-shielding member 207 has a high thermal conductivity for example, it is necessary to make the area of the contact surface 272a smaller in order to reduce the heat transferred from the light-shielding member 207 to the frame 209. This increases the area not being in contact with the frame 209 in the light-shielding member, possibly causing the light-shielding member 207 and frame 209 to be in contact with each other at an unintended portion due to variations in molding. Moreover, as the area of the contact surface 272a is small, it may become difficult to adjust the heat transferring from the light-shielding member to the frame 209 by, for example, adjusting a metal mold.

Furthermore, the heat transferred from the LED substrate 206 to the chassis 205 is not entirely transferred to the light-shielding member 207 but is partly transferred to the back surface side of the chassis 205. In the case where, for example, the thermal conductivity of the chassis 205 is low, the heat from the LED substrate 206 is not easily transferred to other portions via the chassis 205, raising the temperature of the LED substrate 206 and possibly expediting the degradation of the LED 262.

It is, therefore, preferable for the light-shielding member 207 to have a relatively low thermal conductivity, and for the chassis 205 and frame 209 to have a relatively high thermal conductivity.

The liquid-crystal display apparatus having the configuration described above includes the light-shielding member 207 interposed between the chassis 205 and frame 209, and shields the light leaking from the LED 262 or light guide plate 203 to the outside. On the light-shielding member 207, the recess 272b is formed at the contact surface 272a with the frame 209. The recess 272b makes the area of the contact surface 272a smaller, which can reduce the heat transferred from the light-shielding member 207 to the frame 209. By appropriately adjusting the dimension or the like of the recess 272b, the contact area between the light shielding member 207 and the frame 209 can appropriately be adjusted, and the amount of heat transferred from the light-shielding member 207 to the frame 209 can also be adjusted.

Moreover, by forming the recesses 272b at the light-shielding member 207, the contact surface 272a is made to have a comb shape. Accordingly, in the case where the light-shielding member 207 is integrally molded with synthetic resin, a process of, for example, scraping away the projection of the metal mold corresponding to the recess 272b can adjust the area of the contact surface 272a. Such a process can easily be conducted in a metal mold with the contact surface 272a having a comb shape.

Furthermore, the LED substrate 206 is accommodated in the chassis 205 having the bottom surface 251 and circumferential wall part 252, while being in contact with the inner side of the circumferential wall part 252. The light shielding member 207 has a heat dissipation part 272 being in contact with the outside of the circumferential wall part 252 of the chassis 205, and a light-shielding part 271 provided in a manner of being bent or curved with respect the heat dissipation part 272. The heat dissipation part 272 of the light-shielding member 207 has a recess 272b formed at the contact surface 272a being in contact with the chassis 205. The light shielding part 271 of the light-shielding member 207 shields the light leaking from the gap between the light guide plate 203 and chassis 205 while being in contact with the peripheral part of the light guide plate 203. Such a configuration makes it possible to appropriately adjust the amount of heat dissipation to the side surface side of the liquid-crystal display apparatus.

Furthermore, the light-shielding member 207 is constituted by a material having a thermal conductivity lower than that of the chassis 205 or frame 209. For example, the light-shielding member 207 may be integrally molded with synthetic resin such as plastic, while the chassis 205 and frame 209 may be made of metal such as iron or copper. By reducing the thermal conductivity of the light-shielding member 207, the area of the contact surface 272a of the light-shielding member 207 can be increased.

Though the present embodiment has described that the light-shielding member 207 is integrally molded with synthetic resin, the present invention not limited to thereto. For example, it is also possible to divide the frame-like light-shielding member 207 into four sides, which are respectively molded with resin and are fixed by bonding or screwing or the like, or to divide the light-shielding member 207 into an even larger number of components in manufacturing. Though the present embodiment described that the light-shielding member 207 is made of synthetic resin such as plastic, which is a mere example, it may also be made of another material. Likewise, the chassis 205 and frame 209, which have been described to be made of metal such as aluminum, iron or equivalent metal as an example, may also be made of another material.

### Modification 1

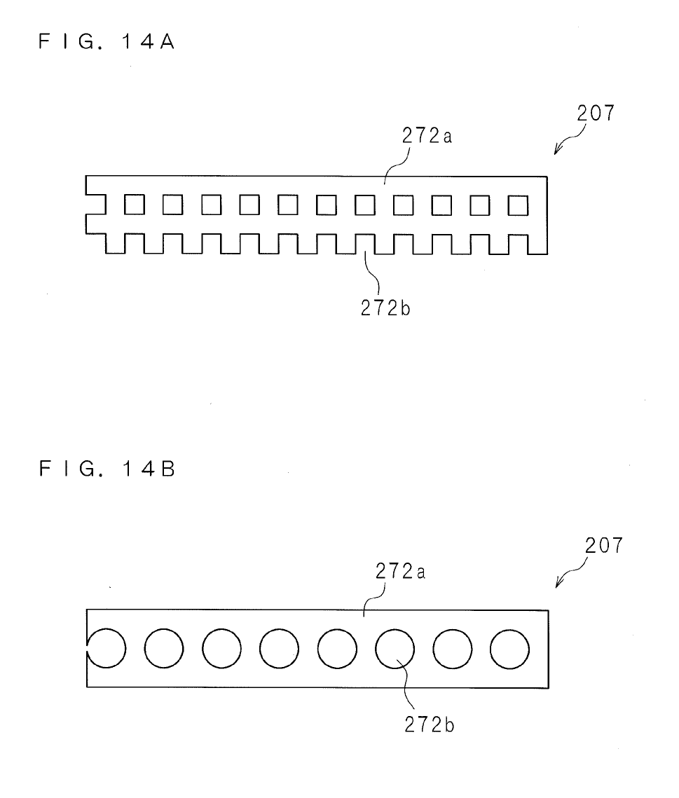

Moreover, while the contact surface 272a of the light-shielding member 207 has a shape of a comb, another shape may also be adopted as described in the modification below. FIG. 14A is a schematic view illustrating a modification of the contact surface 272a of the light shielding member 207. FIG. 14B is a schematic view illustrating a modification of the contact surface 272a of the light shielding member 207. In the light-shielding member 207 illustrated in FIG. 14A, the contact surface 272a has a grid shape. Each of the recesses 272b has a substantially square shape, the recesses 272b being arranged side by side in the vertical and horizontal directions. Furthermore, the light-shielding member 207 illustrated in FIG. 14B is formed by arranging substantially circular recesses 272b in a line, and the contact surface 272a has a substantially-rectangular shape from which the substantially circular parts are removed. It is noted that the contact surface 272a of the light-shielding member 207 is not limited to the illustrated shape but may be various other shapes.

### Modification 2

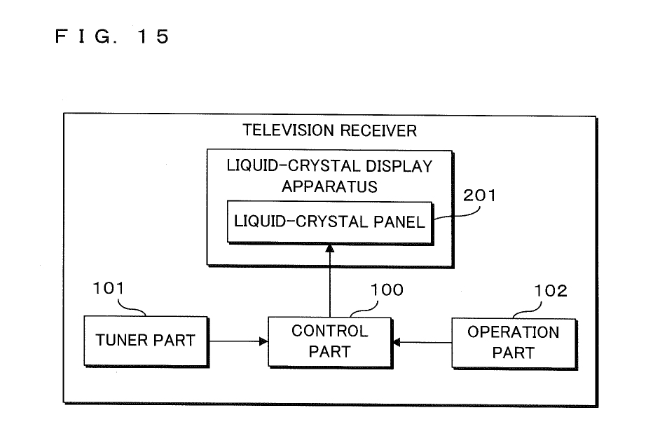

Furthermore, the liquid-crystal display apparatus described above can be applied to a television receiver in which an image concerning a program of television broadcasts is displayed on the liquid-crystal panel 201. FIG. 15 is a block diagram illustrating a configuration of a television receiver according to a modification. The television receiver according to the modification includes a liquid-crystal display apparatus having the above-described configuration having the liquid-crystal panel 201, a tuner part 101 receiving television broadcasts, an operation part 102 accepting an operation of the user, and a control part 100 performing control related to image display in accordance with the television broadcasts received by the tuner part 101 and the operation accepted at the operation part 102.

The tuner part 101 receives predetermined television broadcasts in accordance with the operation of selecting a station performed by the user, and sends the data concerning the received television broadcasts to the control part 100. The control part 100 decodes the data sent from the tuner part 101, performs image processing such as quality correction on image data included in the decoded data, and sends the data obtained after the image processing to the liquid-crystal panel 201 of the liquid-crystal display apparatus. The liquid-crystal panel 201 displays an image based on the data sent from the control part 100. Though not illustrated, the control part 100 outputs sound by sending audio data included in the decoded data to the speaker.

### Embodiment 3

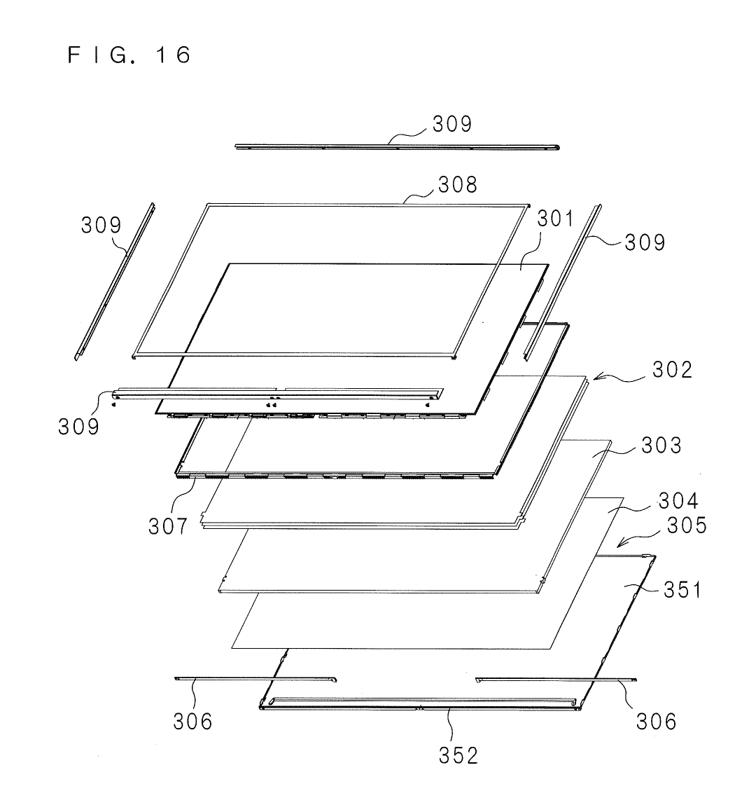

The present invention will specifically be described with reference to the drawings illustrating an embodiment thereof. FIG. 16 is an exploded perspective view illustrating a configuration of a liquid-crystal display apparatus according to the present embodiment. In FIG. 16, the reference numeral 301 denotes a liquid-crystal panel. The liquid-crystal panel 301 is a device having the shape of a substantially rectangular plate and displaying an image by controlling the transmittance of the light irradiating from the back surface for each pixel. At the back surface side of the liquid-crystal panel 301, multiple optical sheets 302, a light guide plate 303 and a reflection plate 304 are layered. The optical sheets 302 corresponds to an optical member for diffusing light, for example, while each sheet has a different optical characteristic. Each optical sheet 302 has a substantially rectangular shape of the same size as or somewhat smaller than the liquid-crystal panel 301, and the optical sheets 302 all have substantially the same shape.

The light guide plate 303 has a substantially rectangular plate shape of the same size as or somewhat smaller than the liquid-crystal panel 301. The light guide plate 303 is an optical member reflecting and diffusing the light entering from a side surface thereof inside, and outputs the light from its front surface. Thus, the light guide plate 303 has a larger thickness compared to the liquid-crystal panel 301, reflection plate 304 and the like. The reflection plate 304 has a substantially rectangular plate-like shape of the same size as or somewhat larger than the light guide plate 303. The reflection plate 304 is a member with its front surface being a mirror surface, and reflects the light output from the back surface of the light guide plate 303 into the light guide plate 303 and further onto the back surface of the liquid-crystal panel 301.

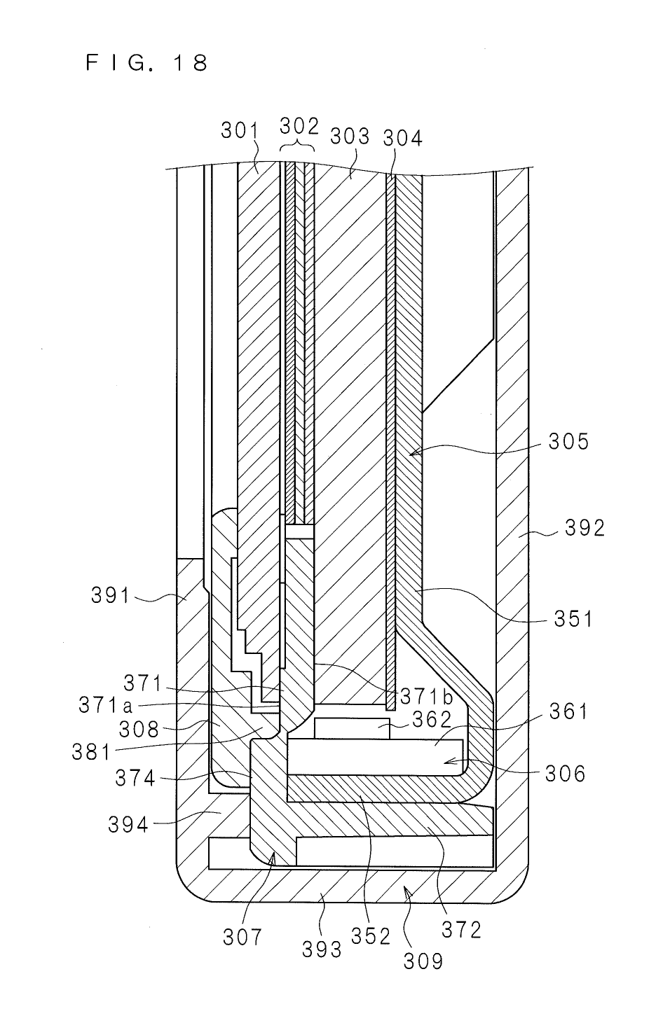

A metal chassis 305 is placed on the back surface of the reflection plate 304. The chassis 305 is a housing which forms the shape of a tray or a container having a substantially rectangular bottom plate 351 covering the back surface of the reflection plate 304 and a circumferential wall part 352 enclosing the bottom plate 351, and accommodates the layered optical sheets 302, light guide plate 303 and reflection plate 304. On the circumferential wall part 352 at the lower side (the side to be on the lower side in the state where the liquid-crystal display apparatus is installed for use) of the chassis 305, an LED substrate 306 is fixed. The LED substrate 306 includes a substrate part 361 (see FIG. 18) formed in the shape of a long and narrow substantially rectangular plate on which multiple LEDs 362 (see FIG. 18) are mounted side by side in the longitudinal direction. The LED substrate 306 is fixed being in contact with the inner surface of the circumferential wall part 352 of the chassis 305, while the LEDs 362 mounted thereon are opposed to the side surface of the light guide plate 303 in this state. Accordingly, the light emitted by the LED 362 enters the light guide plate 303 from the side surface thereof, and the back surface of the liquid-crystal panel 301 is irradiated with the light from the light guide plate 303.

In order to prevent the light of the LEDs 362 from leaking out of the gap between the side surface of the light guide plate 303 accommodated in the chassis 305 and the circumferential wall part 352 of the chassis 305, the liquid-crystal display apparatus includes a light-shielding member 307. The light-shielding member 307 is a member made of synthetic resin having a substantially rectangular frame-like shape, each side thereof forming a substantially L-shaped cross section. The light-shielding member 307 is in contact with the front surface peripheral part of the light guide plate 303 accommodated in the chassis 305 while being in contact with the inner surface or outer surface of the circumferential wall part 352 of the chassis 305. Accordingly, the light-shielding member 307 blocks the gap between the light guide plate 303 and the circumferential wall part 352 of the chassis 305 and prevents the light from leaking. Furthermore, the light-shielding member 307 is so provided to enclose the optical sheets 302 at the front surface of the light guide plate 303, while being in contact with the back surface peripheral part of the liquid-crystal panel 301. In other words, the optical sheet 302 is formed to have a substantially rectangular shape which is smaller than the liquid-crystal panel 301 and the light guide plate 303, and the light-shielding member 307 is placed at the gap between the light guide plate 303 and the liquid-crystal panel 301 on the side part of the optical sheet 302 when the liquid-crystal panel 301, the optical sheets 302 and light guide plate 303 are layered. It is to be noted that the light-shielding member 307 is molded by being divided into four parts corresponding to the respective sides, and is formed to have a frame shape when the liquid-crystal display apparatus is assembled. The joint part for each component of the light-shielding member 307 may have such a configuration of being covered with a light-shielding tape or the like, so as to prevent light from leaking to the outside from the gap between the joint parts. The lower side of the light-shielding member 307 corresponding to the lower side of the liquid-crystal display apparatus has a configuration somewhat different from that of the other sides (upper, left and right sides), which will be described later in detail.

The liquid-crystal display apparatus includes a panel cover 308 being in contact with the front surface peripheral part of the liquid-crystal panel 301, the panel cover 308 forming the shape of a substantially rectangular frame. Thus, the liquid-crystal panel 301 is fixed in such a manner that the peripheral part thereof is sandwiched between the light-shielding member 307 and the panel cover 308.

Moreover, the liquid-crystal display apparatus includes a frame 309 for fixing the components from the liquid-crystal panel 301 to the reflection plate 304 and the like that are layered and accommodated in the chassis 305 as described above. The frame 309 is a metal part serving as an exterior of the liquid-crystal display apparatus. Four frames 309 are provided to correspond to the respective sides, i.e. upper, lower, left and right sides, of the liquid-crystal panel 301 and the like. Each frame 309 is a long and narrow member having a length corresponding to each side of the liquid-crystal panel 301 or the like, having a substantially U-shaped cross section. The frame 309 is fitted with its open part facing inward to tuck in the layered liquid-crystal panel 301 to chassis 305 and the like, to be attached to cover the front surface peripheral part of the liquid-crystal panel 301, the side surface part and the back surface peripheral part of the chassis 305, and is screwed to the chassis 305. Thereby, the liquid-crystal panel 301, optical sheets 302, light guide plate 303, reflection plate 304, chassis 305, light shielding member 307, panel cover 308 and the like are fixed in such a manner that four sides are tucked in the frame 309.

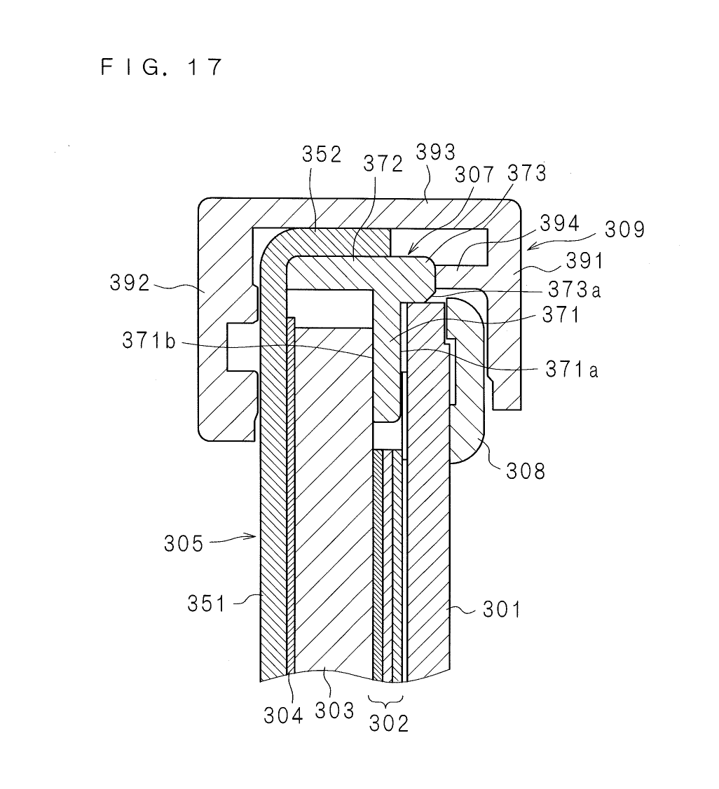

FIG. 17 is a partial enlarged section view illustrating a configuration of a liquid-crystal display apparatus according to an embodiment of the present invention, showing a cross sectional structure of the upper side of the liquid-crystal display apparatus. Though not illustrated, the cross sectional structure of the left and right sides of the liquid-crystal display apparatus is substantially the same as the cross sectional structure on the upper side illustrated in FIG. 17. As described above, the chassis 305 accommodates therein, from the front surface side, the liquid-crystal panel 301, optical sheets 302, light guide plate 303 and reflection plate 304 that are layered.

The light-shielding member 307 has a light-shielding part 371 being in contact with the front surface peripheral part of the light guide plate 303 accommodated in the chassis 305, and the chassis contact part 372 being in contact with the inner surface of the circumferential wall part 352 of the chassis 305. The light-shielding member 307 is formed by bonding the light shielding part 371 and chassis contact part 372 each having the shape of a long and narrow rectangular plate at their long sides so as to form a substantially L-shaped cross section. In the light-shielding part 371 of the light-shielding member 307, the front surface thereof is set as a panel contact surface 371a being in contact with the back surface peripheral part of the liquid-crystal panel 301, and the back surface thereof is set as a light guide plate contact surface 371b being in contact with the front surface peripheral part of the light guide plate 303. The panel contact surface 371a and light guide contact surface 371b are both flat surfaces. The light-shielding part 371 of the light-shielding member 307 has a thickness substantially equal to the thickness of the layered optical sheets 302, and is placed in a manner of being sandwiched between the liquid-crystal panel 301 and the light guide plate 303 as in the optical sheets 302. Since the light-shielding member 307 covers an end portion of the light guide plate 303, the light output from the end portion of the light guide plate 303 will not leak to the back surface side of the liquid-crystal panel 301, preventing the light from leaking outside.

Furthermore, the light-shielding member 307 has a positioning protrusion 373 for determining the position of the liquid-crystal panel 301. The positioning protrusion 373 is formed on an end of the panel contact surface 371a (the end on the side surface side of the liquid-crystal display apparatus) so as to protrude from the panel contact surface 371a to the front surface side of the liquid-crystal display apparatus. At the protruding end of the positioning protrusion 373, an inclined surface 373a formed by chamfering the corner part is provided on the side where the liquid-crystal panel 301 is placed. The inclined surface 373a is for guiding the liquid-crystal panel 301 to the panel contact surface 371a at the time of, for example, assembly of the liquid-crystal display apparatus. The liquid-crystal panel 301 has aback surface being in contact with the panel contact surface 371a and a side surface being in contact with the positioning protrusion 373 so as to be positioned. The positioned liquid-crystal panel 301 is covered with the panel cover 308 at its front surface peripheral part.

The frame 309 on the upper side includes a front surface covering part 391 covering the front surface peripheral part of the liquid-crystal panel 301, a back surface covering part 392 covering the back surface peripheral part of the chassis 305, and a side surface covering part 393 connecting the front surface covering part 391 and the back surface covering part 392 while covering a side surface of the chassis 305. The frame 309 is a member for fixing the layered components from the liquid-crystal panel 301 to the chassis 305 and the like by tucking these components therein. In the frame 309, the front surface covering part 391 is in contact with the front surface of the panel cover 308, the side surface covering part 393 is in contact with the outer surface of the circumferential wall part 352 of the chassis 305, and the back surface covering part 392 is in contact with the back surface of the chassis 305. Moreover, the frame 309 has a pressing part 394 formed to protrude toward the inner surface of the front surface covering part 391 and presses the light-shielding member 307 to the back surface side. The pressing part 394 is in contact with the protruding end of the positioning protrusion 373 of the light-shielding member 307 and presses the light-shielding member 307.

By the frame 309 having a substantially U-shaped cross section sandwiching the peripheral part of the liquid-crystal display apparatus from the front and back surfaces, the front surface covering part 391 of the frame 309 presses the panel cover 308 to the back surface side, while the panel cover 308 presses the liquid-crystal panel 301 and optical sheets 302 to the light-guide plate 303. By the pressing with the pressing part 394 of the frame 309, the light-shielding member 307 presses the light guide plate 303 to the back surface side. Moreover, by the back surface covering part 392 of the frame 309 pressing the chassis 305 to the front surface side, the chassis 305 presses the reflection plate 304 and light guide plate 303 to the front surface side. Thus, the attachment of the frame 309 presses and fixes each member from the front surface and back surface.

FIG. 18 is a partial enlarged section view illustrating a configuration of a liquid-crystal display apparatus according to the present embodiment, showing a cross sectional structure on the lower side of the liquid-crystal display apparatus. The structure on the lower side of the liquid-crystal display apparatus is slightly different from the structure on the upper side (and left and right sides) illustrated in FIG. 17. This is because the LED substrate 306 is mounted on the lower side of the liquid-crystal display apparatus. It is to be noted that the configuration in which the liquid-crystal panel 301, multiple optical sheets 302, light guide plate 303 and reflection plate 304 are layered in this order from the front surface side and are accommodated in the chassis 305 is the same as the configuration illustrated in FIG. 17. However, the LED substrate 306 is fixed on the inner surface of the circumferential wall part 352 on the lower side of the chassis 305 such that the LED 362 is opposed to the side surface of the light guide plate 303.

The light-shielding member 307 on the lower side is in contact with the front surface peripheral part of the light guide plate 303 accommodated in the chassis 305 while having a light-shielding part 371 blocking the gap between the light guide pate 303 and the circumferential wall part 352 of the chassis 305, and a chassis contact part 372 being in contact with the outer surface of the circumferential wall part 352 of the chassis 305. The light-shielding member 307 has a substantially L-shaped cross section due to the light-shielding part 371 and chassis contact part 372. The light-shielding part 371 of the light-shielding member 307 includes a front surface formed as a panel contact surface 371a being in contact with the back surface peripheral part of the liquid-crystal panel 301 and panel cover 308, and a back surface formed as a light guide plate contact surface being in contact with the front surface peripheral part of the light guide plate 303. The light shielding part 371 of the light-shielding member 307 is placed in such a manner that the light-shielding part 371 is sandwiched between the liquid-crystal panel 301 and light guide plate 303 together with the optical sheets 302. Since the light-shielding member 307 covers the end part of the light guide plate 303 as well as the LED substrate 306 placed in the gap between the light guide plate 303 and the chassis 305, the light output from the peripheral part of the light guide plate 303, LED substrate 306 and the like will not lead to the outside. Moreover, the liquid-crystal panel 301 placed in contact with the panel contact surface 371a of the light-shielding member 307 is covered with the panel cover 308 at its front surface peripheral part.

Furthermore, the light-shielding member 307 on the lower side has a positioning protrusion 374 for determining the position of the panel cover 308. The positioning protrusion 374 is formed at an end of the panel contact surface 371a to protrude from the panel contact surface 371a to the front surface side of the liquid-crystal display apparatus. Moreover, on the lower side of the panel cover 308 formed in the shape of a quadrangular frame, a positioning protrusion 381 is formed on the back surface. The positioning protrusion 381 of the panel cover 308 is brought into contact with the positioning protrusion 374 of the light-shielding member 307 (the positioning protrusions 374 and 381 being aligned in the vertical direction of the liquid-crystal display apparatus in this state), so as to determine the position of the panel cover 308. Moreover, as the configuration in which the positioning protrusion 381 of the panel cover 308 is in contact with the side surface of the liquid-crystal panel 301, positioning of the liquid-crystal panel 301 may be performed by the positioning protrusion 381.

The frame 309 on the lower side includes a front surface covering part 391 covering the front surface peripheral part of the liquid-crystal panel 301 and a back surface covering part 392 covering the back surface peripheral part of the chassis 305, and a side surface covering part 393 connecting the front surface covering part 391 and back surface covering part 392 while covering the side surface of the chassis 305. The frame 309 includes the front surface covering part 391 being in contact with the front surface of the panel cover 308, the side surface covering part 393 being in contact with the outer surface of the chassis contact surface 372 of the light-shielding member 307, and a back surface covering part 392 being in contact with the back surface of the chassis 305. Moreover, the frame 309 has a pressing part 394 formed to protrude toward the inner surface of the front surface covering part 391 and presses the light-shielding member 307 to the back surface side. The pressing part 394 is in contact with the positioning protrusion 374 of the light-shielding member 307 and presses the light-shielding member 307.

As in the other sides of the liquid-crystal display apparatus, by the frame 309 on the lower side having a substantially U-shaped cross section sandwiching the peripheral part of the liquid-crystal display apparatus from the front surface and the back surface, the front surface covering part 391 of the frame 309 presses the panel cover 308 to the back surface side, while the panel cover 308 presses the liquid-crystal panel 301 and optical sheets 302 to the light-guide plate 303. By the pressing with the pressing part 394 of the frame 309, the light-shielding member 307 presses the light-guide plate 303 to the back surface side. Moreover, by the back surface covering part 392 of the frame 309 pressing the chassis 305 to the front surface side, the chassis 305 presses the reflection plate 304 and light guide plate 303 to the front surface side. Thus, the attachment of the frame 309 presses the components from the front surface and back surface to fix them.

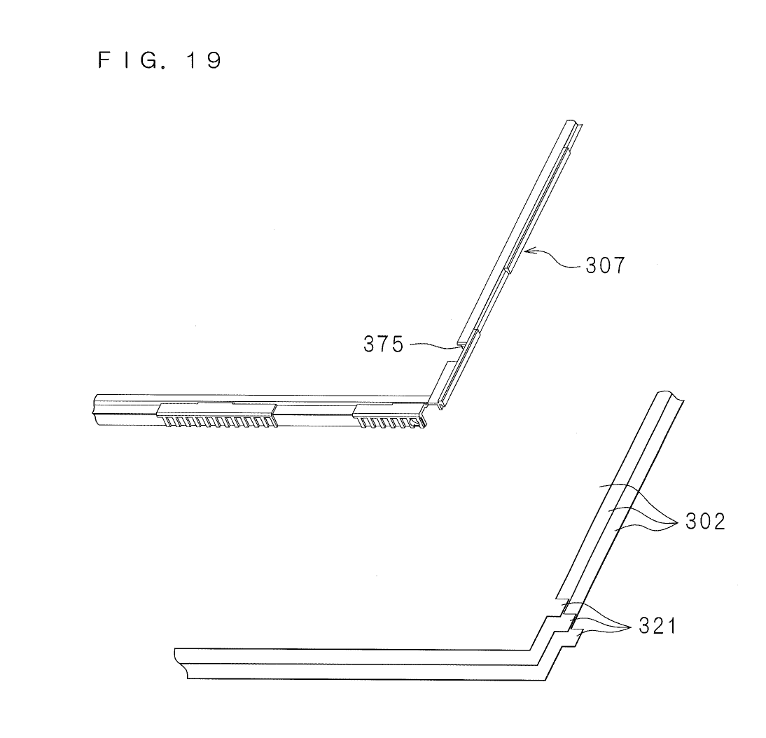

FIG. 19 is an enlarged perspective view illustrating configurations of the optical sheet 302 and the light shielding member 307, showing an enlarged view of the lower right corner of the optical sheets 302 and the light shielding member 307 in FIG. 16 and the periphery thereof. The multiple optical sheets 302 are sheets each having a substantially rectangular shape and having substantially the same shape. Moreover, the light-shielding member 307 has the shape of a quadrangular frame, and the optical sheets 302 are arranged inside the light-shielding member 307 so as to be enclosed thereby in the state of being layered between the light guide plate 303 and the liquid-crystal panel 301.

At the optical sheet 302, an extension part 321 is formed on each of the right and left sides (two short sides) thereof. The extension part 321 is provided extending in the horizontal direction at a position closer to the lower part of each of the right and left sides. The optical sheets 302 all have substantially the same shape. Therefore, the position at which the extension part 321 of each optical sheet 302 extends is substantially the same, and the extension parts 321 are overlapped with one another when the optical sheets 302 are layered. Moreover, each extension part 321 has a substantially rectangular shape.

On each of the right and left sides of the light-shielding member 307, a positioning concave 375 is formed at the inside thereof. The positioning concave 375 is formed to correspond to the extension part 321 of the optical sheet 302, i.e., formed at a position closer to the lower part of each of the right and left sides of the light-shielding member 305 having a quadrangular shape. The positioning concave 375 has a rectangular shape of substantially the same size as or somewhat larger than the extension part 321 in a front view, and can accommodate the extension part 321 of the optical sheet 302. By the substantially rectangular extension part 321 being fitted into the positioning concave 375, the position of the optical sheet 302 at the front surface of the light guide plate 303 is determined.

The liquid-crystal display apparatus with the configuration as described above is so configured that the liquid-crystal panel 301, optical sheets 302 and light guide plate 303 are layered and accommodated in the chassis 305 while the LED substrate 306 is placed on the side surface side of the light guide plate 303 inside the chassis 305, and the liquid-crystal panel 301, chassis 305 and the like are tucked in and covered by the frame 309. In this configuration, the liquid-crystal display apparatus shields the light leaking from the light guide plate 303 or LED substrate 306 to the outside by the light-shielding member 307 being in contact with the front surface peripheral part of the light guide plate 303 and the circumferential wall part 352 of the chassis 305. Moreover, in the case where the frame 309 is attached, it is so configured that the light-shielding member 307 presses the light guide plate 303 to the back surface side, which firmly fix the light guide plate 303 and thus can prevent a positional misalignment from occurring.

Moreover, the light-shielding member 307 is configured to have a panel contact surface 371a being in contact with the back surface peripheral part of the liquid-crystal panel 301 and the light guide plate contact surface 371b being in contact with the front surface peripheral part of the light guide plate 303, and is sandwiched between the peripheral parts of the liquid-crystal panel 301 and the light guide plate 303. On the upper, left and right sides of the light-shielding member 307 having the shape of a quadrangular frame, a positioning protrusion 373 is formed for determining the position of the liquid-crystal panel 301 with respect to the direction along the panel contact surface 371a. This can facilitate the positioning of the liquid-crystal panel 301 and improve the accuracy thereof. Moreover, the panel contact surface 371a is formed as a flat surface, while an inclined surface 373a is formed at the positioning protrusion 373. Thus, the positioning of the liquid-crystal panel 301 may be performed by moving it along the inclined surface 373a to the panel contact surface 371a.

Furthermore, in the chassis 305 having the substantially rectangular bottom plate 351 and quadrangular frame-shaped circumferential wall part 352, an LED substrate 306 is accommodated by being in contact with the inner surface of the circumferential wall part 352 corresponding to the lower side of the liquid-crystal display apparatus. The light-shielding member 307 having the shape of a quadrangular frame is configured to be in contact with the outer surface of the circumferential wall part 352 at the lower side thereof, and to be in contact with the inner surface of the circumferential wall part 352 at the other sides, i.e., upper, left and right sides thereof. Accordingly, the light-shielding member 307 can prevent the light emitted by the LED 362 mounted on the LED substrate 306 from leaking to the outside of the frame 309. Moreover, for the upper, left and right sides on which no LED substrate 306 is provided can have narrower border widths.

Furthermore, the optical sheets 302 and the light-shielding member 307 are both configured to be sandwiched between the liquid-crystal panel 301 and light guide plate 303, while the layered optical sheets 302 are arranged inside the light-shielding member 307 having the shape of a quadrangular frame. In this configuration, an extension part 321 is provided at a position closer to the lower part of the left and right sides of the optical sheet 302, while the positioning concave 375 is formed at a position corresponding to the light-shielding member 307. Thus, by accommodating the extension part 321 of the optical sheet 302 into the positioning concave 375 of the light-shielding member 307, positioning of the optical sheets 302 may easily be performed with high accuracy.

While the light-shielding member 307 of a quadrangular frame shape is manufactured by dividing it into four parts for the respective sides in the present embodiment, it is not limited thereto but may also be manufactured by integral molding as one component or by dividing it into three, five or more parts. Moreover, the light-shielding member 307 made of synthetic resin such as plastic, which is a mere example, may also be formed with another material. Likewise, the chassis 305 and frame 309 made of metal, which is a mere example, may also be formed with another material. While the light-shielding member 307 is configured to be in contact with the inner surface of the circumferential wall part 352 on the upper, left and right sides, the present invention is not limited thereto but may be configured to be in contact with the outer surface of the circumferential wall part 352. Though the optical sheet 302 is configured to have the extension part 321 close to a lower part on each of the left and right sides, the present invention is not limited thereto. The position and number of the extension parts 321 are not limited to the configuration illustrated in the present embodiment.

### Modification 3

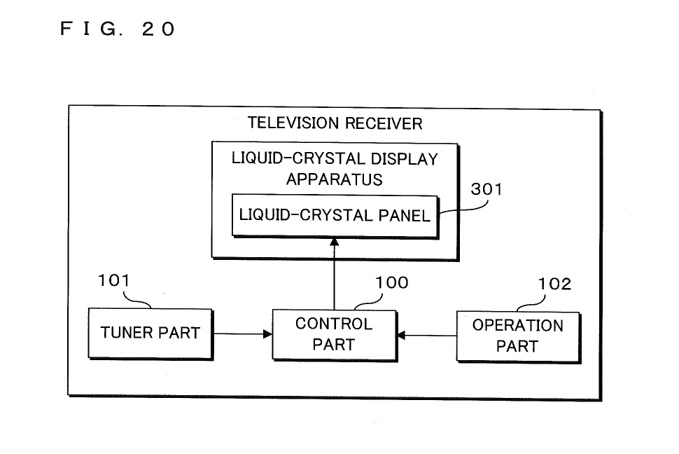

The liquid-crystal display apparatus as described above can be applied to a television receiver displaying an image concerning a program in television broadcasts on the liquid-crystal panel 301. FIG. 20 is a block diagram illustrating a configuration of a television receiver according to a modification. The television receiver according to the modification includes a liquid-crystal display apparatus with the above-described configuration having the liquid-crystal panel 301, a tuner part 101 receiving television broadcasts, an operation part 102 accepting an operation of a user, and a control part 100 performing control concerning image display in accordance with the television broadcasts received by the tuner part 101 and the operation accepted by the operation part 102.

The tuner part 101 receives predetermined television broadcasts according to the operation of selecting a station performed by the user, and sends data concerning the received television broadcasts to the control part 100. The control part 100 decodes the data sent from the tuner part 101, performs image processing such as image quality correction on the image data included in the decoded data, and sends the data obtained after image processing to the liquid-crystal panel 301 of the liquid-crystal display apparatus. The liquid-crystal panel 301 displays an image based on the data sent from the control part 100. Though not illustrated, the control part 100 outputs sound by sending sound data included in the decoded data to a speaker.

### Embodiment 4

A display apparatus according to an embodiment of the present invention will now be described by taking a television receiver as an example.

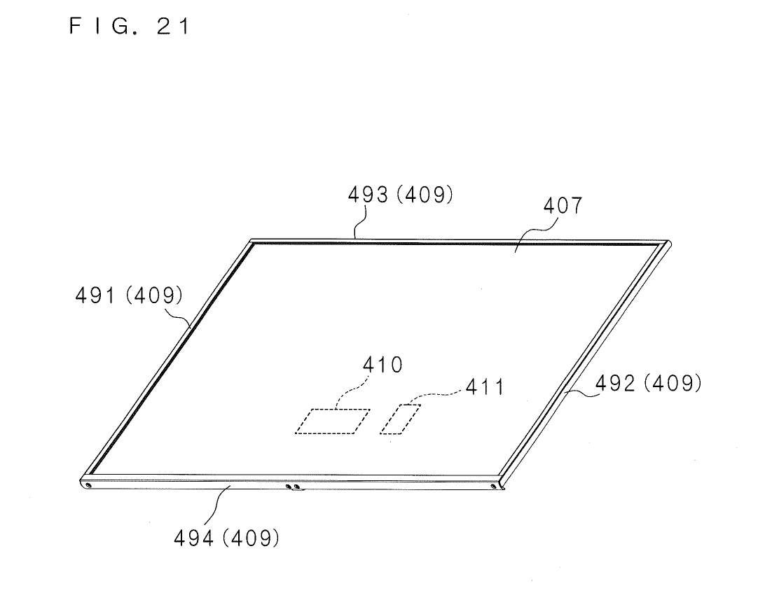

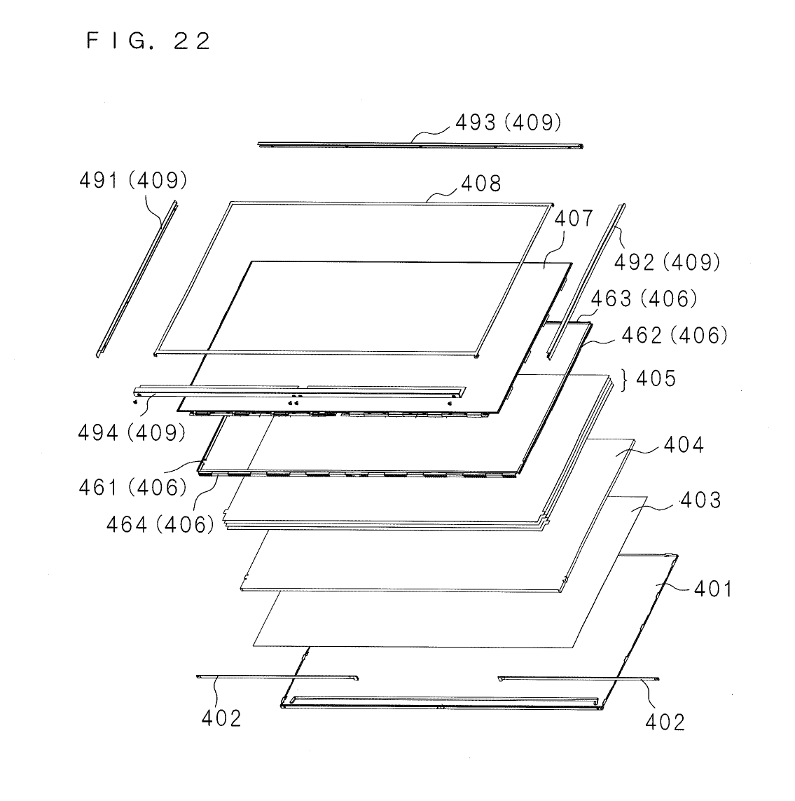

FIG. 21 is a perspective view of an outer appearance of a television receiver. FIG. 22 is an exploded perspective view of a main part of the television receiver. The television receiver includes a backlight chassis 401 (holding body), an LED (Light Emitting Diode) substrate 402, a reflection sheet 403, a light guide plate 404, an optical sheet 405, an optical member holder 406 (fixing member), a liquid-crystal panel 407 (display panel), a panel cover 408, a frame 409, a tuner board 410 and a power supply board 411.

In the description below, the side of the television receiver on which the liquid-crystal panel 407 is located is referred to as a front side, or simply “front.” The opposite side of the front side is referred to as a rear side or simply “rear.” The left side of the liquid-crystal panel 407 as shown in the drawing is referred to as a left side or simply “left.” The right side of the liquid-crystal panel 407 as shown in the drawing is referred to as a right side or simply “right.” In the case where the television receiver stands vertically, the upper direction of the liquid-crystal panel 407 is referred to as an upper side or simply “top.” Likewise, the lower direction of the liquid-crystal panel 407 is referred to as a lower side or simply “bottom.”

Moreover, each component of the television receiver is described for the direction in the state of being assembled in the television receiver, unless otherwise specified.

The backlight chassis 401 has the shape of a shallow box with one surface being open. The backlight chassis 401 forms a part of the casing of the television receiver. The backlight chassis 401 is formed with metal, for example, a steel plate in order to secure its strength. The backlight chassis 401 is formed by press molding. If the strength can be secured, the backlight chassis 401 may be formed with light metal such as an aluminum.

The LED substrate 402 has the shape of a rectangular flat plate, and is a long and narrow substrate (rectangular substrate). On the LED substrate 402, an LED is mounted as a light emitting element. In order to efficiently dissipate the heat generated by the LED, the LED substrate 402 is formed with an aluminum. The LED substrate 402 is formed by two symmetrical plates.

The light guide plate 404 has the shape of a rectangular plate which is a little smaller than the backlight chassis 401. The light guide plate 404 is made of synthetic resin such as acrylic resin, polycarbonate resin, methacrylate resin or cyclic polyolefin.

The reflection sheet 403 has substantially the same shape as the light guide plate 404 in a plan view. The reflection sheet 403 is a synthetic resin sheet. The reflection sheet 403 has a function of totally reflecting the incident light. The optical sheet 405 is comprised of multiple sheets. The multiple sheets constituting the optical sheet 405 includes a diffusion sheet, a reflection/polarization sheet, a lens sheet and the like. The optical sheet 405 is a synthetic resin sheet. The optical sheet 405 is a laminated body in which the sheets as described above are laminated.

The optical member holder 406 has the shape of a frame. The optical member holder 406 is constituted by four bar-like members each having a substantially L-shaped cross section. The four bar-like member constituting the optical member holder 406 are a left side holder 461, a right side holder 462, an upper side holder 463 and a lower side holder 464. Each of the members constituting the optical member holder 406 is formed with engineering plastic such as polycarbonate, polyacetal or polyamide.

The liquid-crystal panel 407 has the shape of a substantially rectangular parallelepiped, which displays an image on the front side thereof. The panel cover 408 is a member having the shape of a rectangular frame. The panel cover 408 covers the peripheral part of the liquid-crystal panel 407. The liquid-crystal panel 407 is fixed by a frame 409 through the panel cover 408.

The frame 409 is constituted by four long and narrow bar-like members each having a U-shaped cross section. The members constituting the frame 409 are a left frame 491, a right frame 492, an upper frame 493 and a lower frame 494. The left frame 491 covers the left side surface of the television receiver. The right frame 492 covers the right side surface of the television receiver. The upper frame 493 covers the upper side of the television receiver. The lower frame 494 covers the lower side of the television receiver. Each component of the television receiver is sandwiched and fixed between two opposing surfaces of the frames.

The tuner board 410 receives television broadcasts and takes out broadcast signals. Based on the broadcast signals taken out by the tuner board 410, an image is displayed on the liquid-crystal panel 407. The power supply board 411 supplies power of a predetermined voltage to each part of the television receiver. The tuner board 410 and power supply board 411 are fixed with screws at the outside on the rear surface of the backlight chassis 401. The tuner board 410 and the power supply board 411 fixed to the backlight chassis 401 are covered with a board cover (not illustrated) for protection.

The television receiver having a configuration as described above is assembled as follows. The LED substrate 402 is fixed to a plate-like portion extending from the rear side to the front side below the backlight chassis 401. The reflection sheet 403 is placed on the box-like bottom plate portion of the backlight chassis 401. The light guide plate 404 is placed on the reflection sheet 403. The light guide plate 404 is so positioned as to maintain a predetermined distance between the end surface on the lower side thereof and an LED mounting surface of the LED substrate 402. The optical sheet 405 is placed on the light guide plate 404. The optical member holder 406 is fixed to the backlight chassis 401. By the optical member holder 406 being fixed, the light guide plate 404 is positioned and fixed. By the optical member holder 406 being fixed, the optical sheet 405 is also positioned.

The liquid-crystal panel 407 is placed on the optical sheet 405 and optical member holder 406. Moreover, the panel cover 408 covering the peripheral part of the liquid-crystal panel 407 is placed thereon. The frame 409 sandwiches and fixes the layered members from the backlight chassis 401 to panel cover 408.

In the television receiver configured as described above, the light emitted by the LED enters the light guide plate 404 from a side edge thereof. Since the reflection sheet 403 is located at the rear side of the light guide plate 404, the light travelling in the rear side direction of the light guide plate 404 is reflected by the reflection sheet 403. The light reflected by the reflection sheet 403 irradiates the liquid-crystal panel 407 from the rear side. The liquid-crystal panel 407 is controlled so as to display an image on the front side of the liquid-crystal panel 407.

The optical member holder 406 is responsible for three roles. The first role of the optical member holder 406 is to position the reflection sheet 403, light guide plate 404, optical sheet 405 and liquid-crystal panel 407. The second role of the optical member holder 406 is to fix the light guide plate 404. The third role of the optical member holder 406 is to shield the light of the LED leaking to the outside.

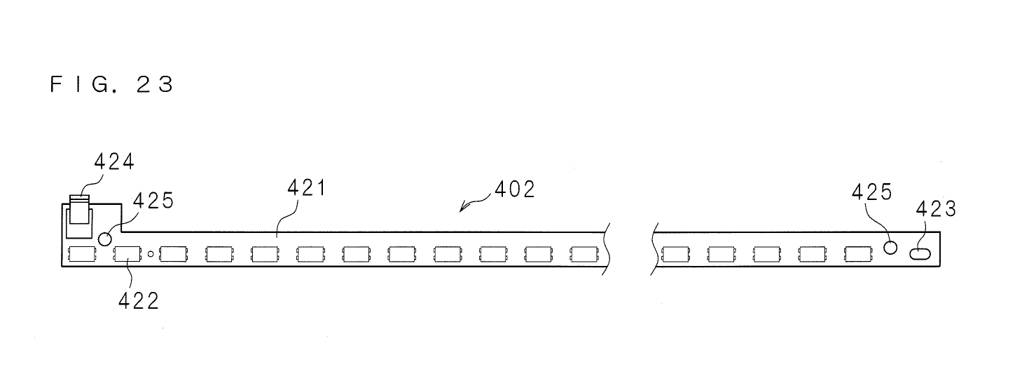

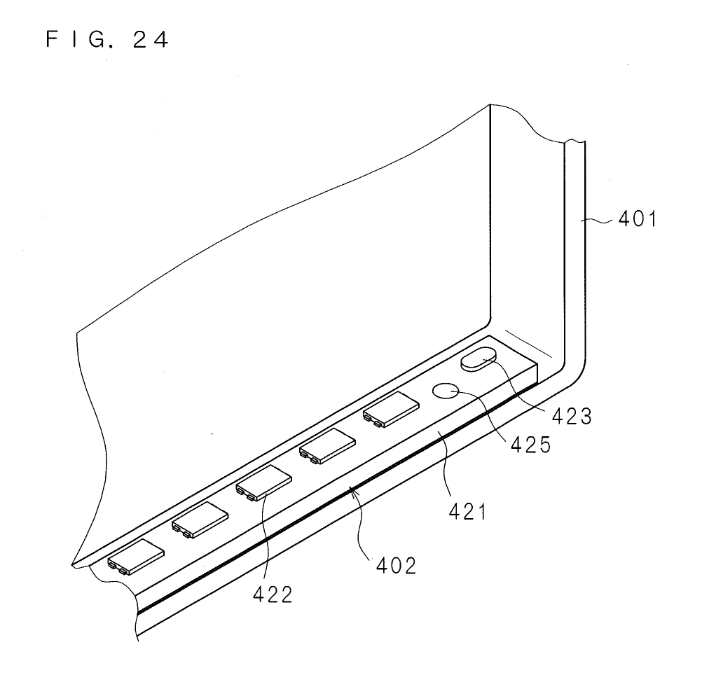

FIG. 23 is a plan view of an LED substrate 402. FIG. 24 is a perspective view illustrating a manner in which the LED substrate 402 is attached. FIG. 23 illustrates an LED substrate 402 supplying light to the right half of the light guide plate 404. The LED substrate 402 supplying light to the left half of the light guide plate 404 has a symmetrical structure to the LED substrate 402 illustrated in FIG. 23. FIG. 24 shows the lower right corner of the television receiver. The LED substrate 402 includes a substrate main body 421, an LED element 422, a spacer 423 (positioning member), a connector 424 and a screw hole 425.

The substrate main body 421 has a flat rectangular shape which is a long and narrow shape. The substrate main body 421 is formed with an aluminum having high thermal conductivity. Multiple LED elements 422 are mounted at equal intervals on one surface of the substrate main body 421. The other surface of the substrate main body 421 is fixed to the backlight chassis 401. The LED element 422 is an element for supplying light to the liquid-crystal panel through the light guide plate 404. The color of light emitted by the LED element 422 is white.

A spacer 423 is located at one end of one surface of the substrate main body 421. On the other end of this one surface of the substrate main body 421, a connector 424 is provided. The LED substrate 402 is fixed to the backlight chassis 401 such that the spacer 423 is oriented in the outside direction of the television receiver and the connector 424 is oriented in the inside direction of the television receiver. A screw hole 425 is formed at each of the inner side of the spacer 423 and the inner side of the connector 424 in the LED substrate 402.

The connector 424 is for connecting a cable supplying power to each LED element 422. In the screw hole 425, a screw for integrally fixing the lower frame 494, backlight chassis 401 and LED substrate 402 is to be screwed. A double-sided tape with high thermal conductivity is adhered over the entire rear surface (surface on the side of the backlight chassis) of the substrate main body 421. The double-sided tape fixes the LED substrate 402 to the backlight chassis 401. Moreover, the heat generated by the LED element 422 is dissipated to the backlight chassis 401 through the double-sided tape.

The spacer 423 is a member of an elliptic cylindrical shape or a polygonal columnar shape. The spacer 423 is formed with resin having a heatproof temperature of approximately 90 to 100 degrees, because it needs to be formed with a material which is not deformed or transformed even if the temperature is increased due to the heat generated from the LED element 422. For example, the spacer 423 is formed with polycarbonate, polyamide, polyacetal, polybutylene terephthalate, fluorine resin or the like. The spacer 423 is fixed to the substrate main body 421 of the LED substrate 402 with a double-sided tape.

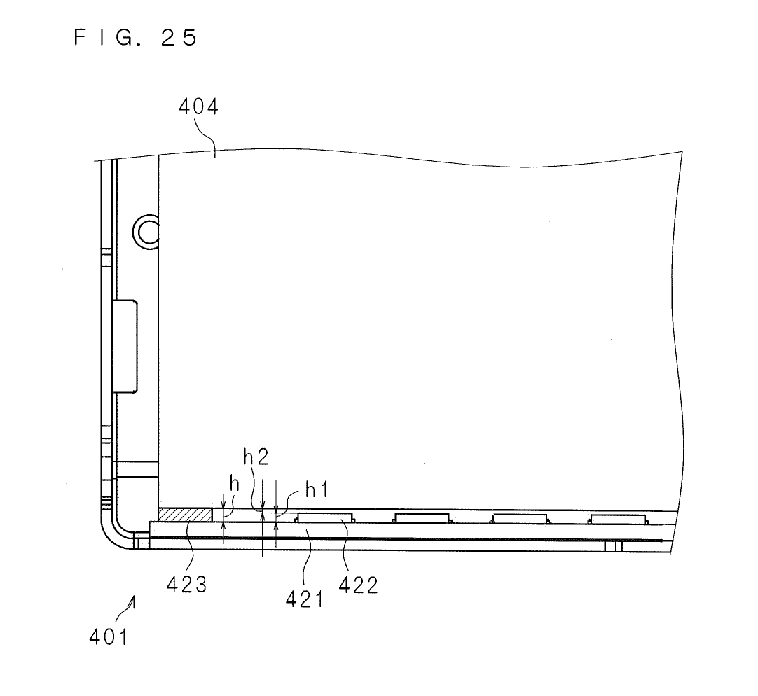

FIG. 25 is a plan view illustrating a manner of a light guide plate 404 positioned by a spacer 423. The lower left portion of the television receiver is illustrated. The spacer 423 is for positioning the light-guide plate 404. The height h of the spacer 423 is defined by a height h1 corresponding to the LED element 422 protruding from the substrate main body 421 and an appropriate distance h2 between the light guide plate 404 and the LED element 422. The height h of the spacer 423 is a value obtained by summing h1 and h2. It is to be noted that the appropriate distance h2 between the light guide plate 404 and the LED element 422 is approximately 0.3 mm to 0.5 mm.

The structure symmetrical to that shown in FIG. 25 is also provided at the lower right portion of the television receiver. By the lower surface of the light guide plate 404 being in contact with the spacer 423 located on the LED substrate 402, the positioning of the light guide plate 404 in the vertical direction can precisely be performed. Note that the light guide plate 404 expands due to the heat generated by the LED element 422. The expansion may cause the part of the light guide plate 404 which is in contact with the spacer 423 to move. It is, therefore, desirable to form the spacer 423 with a material having a small coefficient of friction, which allows the light guide plate 404 to easily slide.

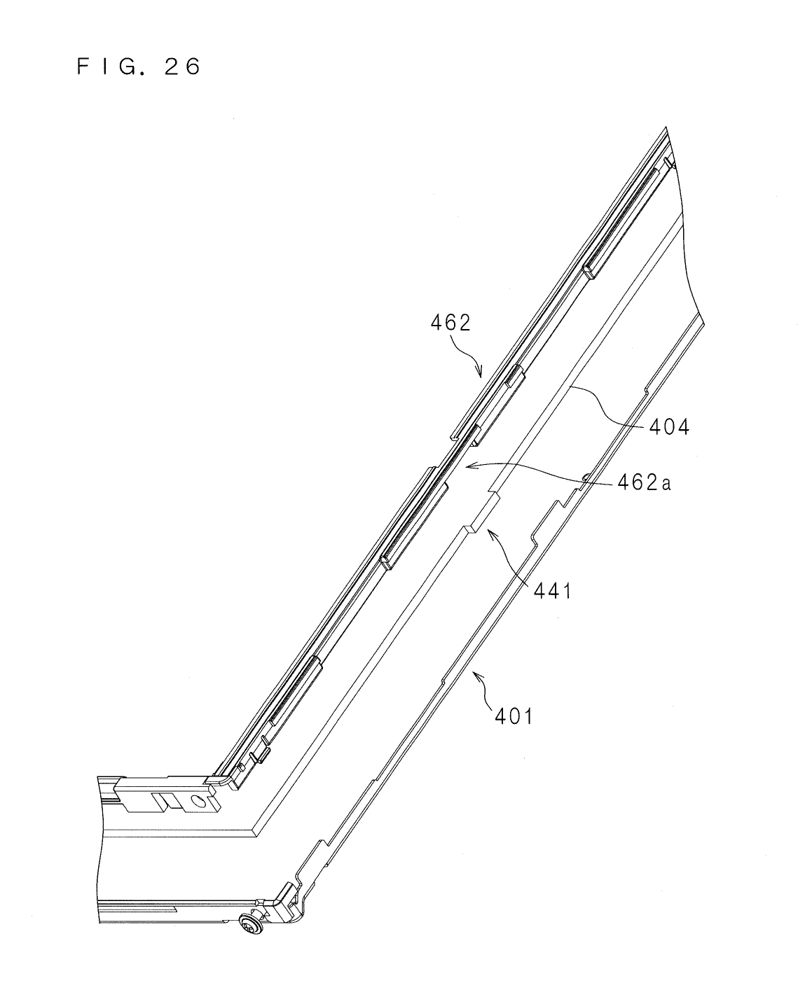

FIG. 26 is a partial perspective view for illustrating a method of fixing the light guide plate 404. For the sake of simplicity, the right side holder 462 constituting the backlight chassis 401, light guide plate 404 and optical member holder 406 is illustrated. A convex part 441 is formed on the right side surface of the light guide plate 404. A concave part 462a is formed on the right side surface of the right side holder 462. In the state of being positioned in the backlight chassis 401, the right side holder 462 is fitted with the backlight chassis 401. By the concave part 462a and the convex part 441 being fitted with each other, the movement of the light guide plate 404 in the vertical direction is restricted. While FIG. 26 shows the right side surface of the television receiver, a structure symmetrical thereto is also provided on the left side surface of the television receiver.

As described above, in the television receiver according to Embodiment 4, it is possible to perform positioning of the light guide plate 404 in the vertical direction by the spacer 423 located on the LED substrate 402. This makes it possible to assemble the television receiver while keeping the gap between the LED element 422 and the lower surface of the light guide plate 404 within a predetermined range.

### Embodiment 5

Though the spacer 423 is formed with resin and fixed to the substrate main body 421 of the LED substrate 402 with a double-sided tape in Embodiment 4, it may also be mounted on the LED substrate 402. Embodiment 5 is different from Embodiment 4 only in a part of the material for the spacer 423 and the fixing method. The other aspects are similar to those in Embodiment 4. Here, the parts different from Embodiment 4 is mainly described. The spacer 423 used in Embodiment 5 is a spacer to be mounted on a substrate. The spacer 423 is formed by fixing a flat-plate-shaped metal piece on the outer surface of a resin material having an elliptic cylindrical shape or a polygonal columnar shape. The spacer 423 may be soldered to the substrate main body 421. In Embodiment 5, the spacer 423 is mounted on the substrate body 421 by a chip mounter using the same process as that for the LED element 422, and is reflow soldered. The spacer 423 may reuse a chip component which has become unnecessary. As described above, the material of the spacer 423 at the part being in contact with the end surface of the light guide plate 404 may preferably be a material for the light guide plate 404 to easily slide thereon.

In Embodiment 5, the spacer 423 can be mounted in the same process as that for the LED element 422. This makes it possible to assemble the television receiver without much increase in the number of assembling works associated with mounting of the spacer 423.

### Embodiment 6

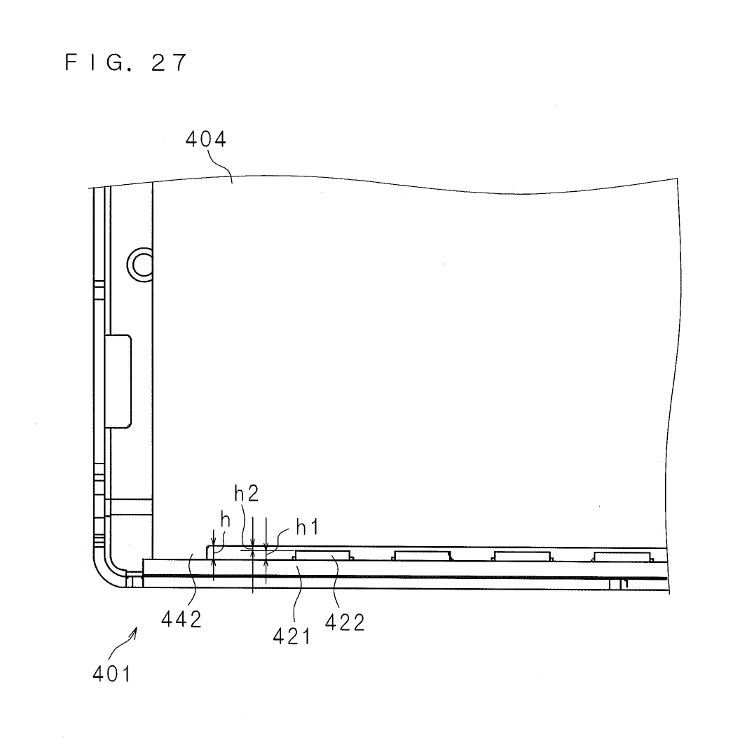

While the spacer 423 is located on the LED substrate 402 in Embodiment 4 and Embodiment 5, a portion corresponding to the spacer 423 may also be provided on the light guide plate 404. FIG. 27 is a plan view illustrating a manner of the light guide plate 404 positioned by a lower convex part 442 formed on the light guide plate 404. The lower left side of the television receiver is illustrated. A structure symmetrical to that shown in FIG. 27 is provided at the lower right side of the television receiver. As illustrated in FIG. 27, the lower convex part 442 is formed on each of the lower left end and the lower right end of the light guide plate 404. The lower convex part 442 is formed by a protruding part of the lower side of the light guide plate 404. The protruding length h is defined by a height h1 corresponding to the LED element 422 protruding from the substrate main body 421 and an appropriate distance h2 between the light guide plate 404 and the LED element 422. The protruding length h is a value obtained by summing h1 and h2.

The technical features (components) described in the embodiments can be combined with one another, and a new technical feature may be formed by such combinations.

The embodiments disclosed herein are to be construed as illustrative and not limitative in all aspects. The scope of the invention is defined by the appended claims rather than by the description preceding them, and all changes that fall within metes and bounds of the claims, or equivalence of such metes and bounds thereof are therefore intended to be embraced by the claims.

### Additional Statement 16

A display apparatus, characterized by comprising a display panel with a front side on which an image is displayed, a rectangular substrate on which a light emitting element is mounted, a light guide plate located at the rear side of the display panel, for outputting light entering a side surface opposed to the light emission element in a rear surface direction of the display panel to irradiate the display panel, a holding body for holding a peripheral part of the light guide plate, a fixing member for fixing the light guide plate to the holding body, and characterized in that a positioning member, protruding toward the light guide plate, for positioning the light guide plate with respect to the light emitting element is located at an end in a longitudinal direction of the light emitting element mounting surface of the rectangular substrate, and that an end surface opposed to the light emitting element of the light guide plate is configured to be in contact with a tip end surface of the positioning member.

### Additional Statement 17

The display apparatus as described in Additional Statement 16, characterized in that the positioning member is adhered to the rectangular substrate with a double-sided tape.

### Additional Statement 18

The display apparatus as described in Additional Statement 16 or 17, characterized in that the positioning member is formed with resin.

### Additional Statement 19

The display apparatus as described in Additional Statement 16, characterized in that the positioning member is an electronic component and is mounted on the rectangular substrate.

### Additional Statement 20

The display apparatus as described in any one of Additional Statements 16 to 19, characterized in that the light emitting element is an LED.

### Embodiment 7

A display apparatus according to an embodiment of the present invention will be described below by taking a television receiver as an example.

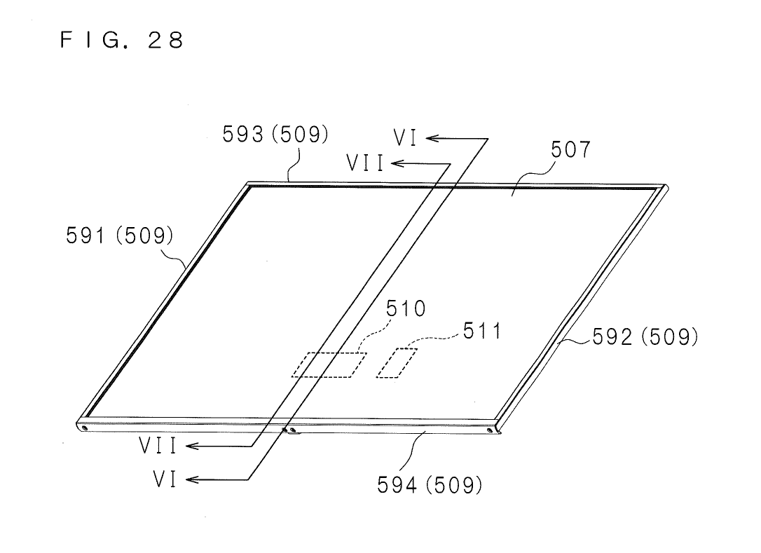

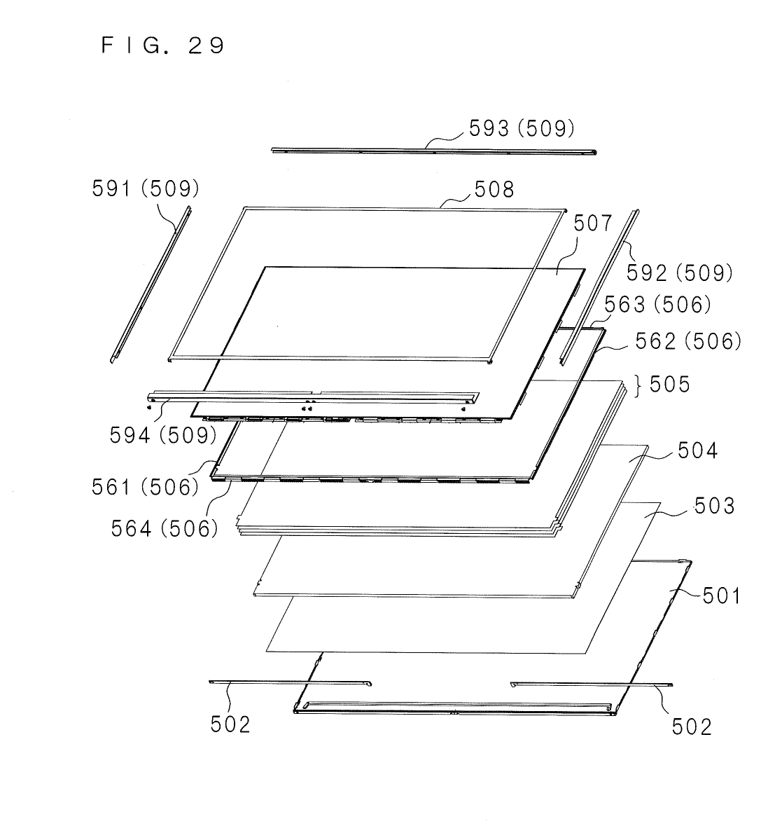

FIG. 28 is a perspective view of an outer appearance of a television receiver. FIG. 29 is an exploded perspective view of a main part of the television receiver. The television receiver includes a backlight chassis 501 (holding body), an LED (Light Emitting Diode) substrate 502, a reflection sheet 503, a light guide plate 504, an optical sheet 505, an optical member holder 506 (fixing member), a liquid-crystal panel 507 (display panel), a panel cover 508 (frame body), a frame 509, a tuner board 510, and a power supply board 511.

In the description below, the side of the television receiver on which the liquid-crystal panel 507 is located is referred to as a front side, or simply “front.” The opposite side of the front side is referred to as a rear side or simply “rear.” The left side of the liquid-crystal panel 507 as shown in the drawing is referred to as a left side or simply “left.” The right side of the liquid-crystal panel 507 as shown in the drawing is referred to as a right side or simply “right.” In the case where the television receiver stands vertically, the upper direction of the liquid-crystal panel 507 is referred to as an upper side or simply “top.” Likewise, the lower direction of the liquid-crystal panel 507 is referred to as a lower side or simply “bottom.”

Moreover, each component of the television receiver is described for the direction in the state of being assembled in the television receiver, unless otherwise specified.

The backlight chassis 501 has the shape of a shallow box with one surface being open. The backlight chassis 501 forms a part of the casing of the television receiver. The backlight chassis 501 is formed with metal, for example, a steel plate in order to secure its strength. The backlight chassis 501 is formed by press molding. If the strength can be secured, the backlight chassis 501 may be formed with light metal such as an aluminum.

The LED substrate 502 has the shape of a rectangular flat plate, and is a long and narrow substrate. On the LED substrate 502, an LED is mounted as a light emitting element. In order to efficiently dissipate the heat generated by the LED, the LED substrate 502 is formed with an aluminum. The LED substrate 502 is formed by two symmetrical pieces.

The light guide plate 504 has the shape of a rectangular plate which is a little smaller than the backlight chassis 501. The light guide plate 504 is made of synthetic resin such as acrylic resin, polycarbonate resin, methacrylate resin or cyclic polyolefin.

The reflection sheet 503 has substantially the same shape as the light guide plate 504 in a plan view. The reflection sheet 503 is a synthetic resin sheet. The reflection sheet 503 has a function of totally reflecting the incident light. The optical sheet 505 is comprised of multiple sheets. The multiple sheets constituting the optical sheet 505 includes a diffusion sheet, a reflection/polarization sheet, a lens sheet and the like. The optical sheet 505 is a synthetic resin sheet. The optical sheet 505 is a laminated body in which the sheets as described above are laminated.

The optical member holder 506 has the shape of a frame. The optical member holder 506 is constituted by four bar-like members each having a substantially L-shaped cross section. The four bar-like members constituting the optical member holder 506 are a left side holder 561, a right side holder 562, an upper side holder 563 and a lower side holder 564. Each of the members constituting the optical member holder 506 is formed with engineering plastic such as polycarbonate, polyacetal or polyamide.

The liquid-crystal panel 507 has the shape of a substantially rectangular parallelepiped, which displays an image on the front side thereof. The panel cover 508 is a member having the shape of a rectangular frame. The panel cover 508 covers the peripheral part of the liquid-crystal panel 507. The liquid-crystal panel 507 is fixed by a frame 509 through the panel cover 508.

The frame 509 is constituted by four long and narrow bar-like members each having a U-shaped cross section. The members constituting the frame 509 are a left frame 591, a right frame 592, an upper frame 593 and a lower frame 594. The left frame 591 covers the left side surface of the television receiver. The right frame 592 covers the right side surface of the television receiver. The upper frame 593 covers the upper side of the television receiver. The lower frame 594 covers the lower side of the television receiver. Each component of the television receiver is sandwiched and fixed between two opposing surfaces of the frames.

The tuner board 510 receives television broadcasts and takes out broadcast signals. Based on the broadcast signals taken out by the tuner board 510, an image is displayed on the liquid-crystal panel 507. The power supply board 511 supplies power of a predetermined voltage to each part of the television receiver. The tuner board 510 and power supply board 511 are fixed with screws at the outside on the rear surface of the backlight chassis 501. The tuner board 510 and the power supply board 511 fixed to the backlight chassis 501 are covered with a board cover (not illustrated) for protection.

The television receiver having a configuration as described above is assembled as follows. The LED substrate 502 is fixed to a plate-like portion extending from the rear side to the front side at the lower side of the backlight chassis 501. The reflection sheet 503 is placed on the box-like bottom plate portion of the backlight chassis 501. The light guide plate 504 is placed on the reflection sheet 503. The light guide plate 504 is so positioned as to maintain a predetermined distance between the end surface on the lower side thereof and an LED mounting surface of the LED substrate 502. The optical sheet 505 is placed on the light guide plate 504. The optical member holder 506 is fixed to the backlight chassis 501. By the optical member holder 506 being fixed, the light guide plate 504 is positioned and fixed. By the optical member holder 506 being fixed, the position of the optical sheet 505 is also determined.

The liquid-crystal panel 507 is placed on the optical sheet 505 and optical member holder 506. Moreover, the panel cover 508 covering the peripheral part of the liquid-crystal panel 507 is placed thereon. The frame 509 sandwiches and fixes the layered members from the backlight chassis 501 to panel cover 508.

In the television receiver configured as described above, the light emitted by the LED enters the light guide plate 504 from a side edge thereof. Since the reflection sheet 503 is located at the rear side of the light guide plate 504, the light travelling in the rear side direction of the light guide plate 504 is reflected by the reflection sheet 503. The light reflected by the reflection sheet 503 irradiates the liquid-crystal panel 507 from the rear side. The liquid-crystal panel 507 is controlled so as to display an image on the front side of the liquid-crystal panel 507.

The optical member holder 506 is responsible for three roles. The first role of the optical member holder 506 is to position the reflection sheet 503, light guide plate 504, optical sheet 505 and liquid-crystal panel 507. The second role of the optical member holder 506 is to fix the light guide plate 504. The third role of the optical member holder 506 is to shield the light of the LED leaking to the outside.

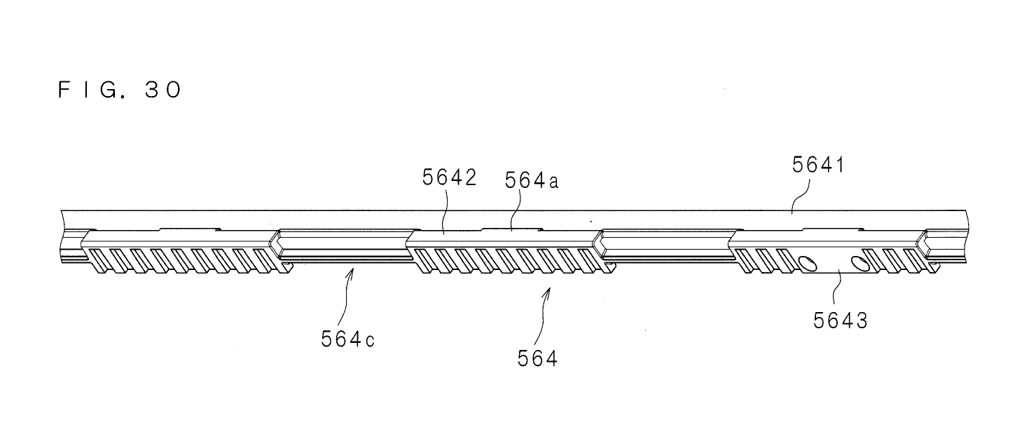

FIG. 30 is a partial perspective view of a lower side holder 564. The lower side holder 564 is a bar-like member having an L-shaped cross section. One surface (plate-like part) of the lower side holder 564 forming an L-shaped cross section corresponds to a display panel touching part 5641 (periphery touching part) and a panel cover contact part 5642 (frame contact part). The other surface forming the L-shaped cross section corresponds to a lower side plate-like part 5643. The panel cover contact part 5642 is intermittently provided in the longitudinal direction of the lower side holder. The panel cover contact part 5642 connects the display panel touching part 5641 and the lower side plate-like part 5643. The lower side plate-like part 5643 is thick in the front-back direction (up-down direction in FIG. 30) at the portion to be connected with the panel cover contact part 5642. A concave part 564c is formed between panel cover contact parts 5642.

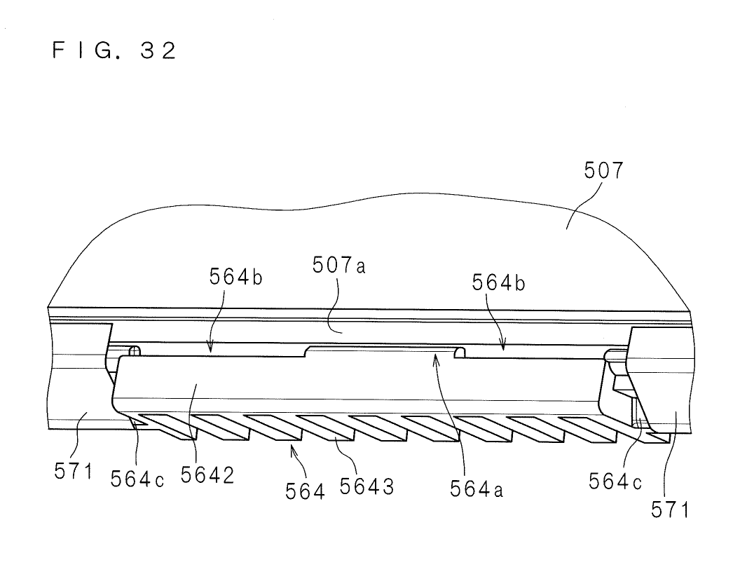

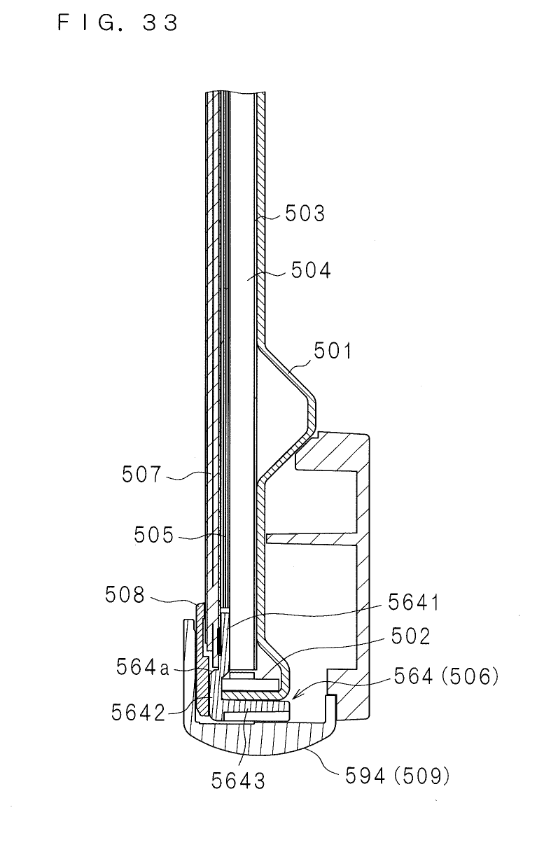

At the panel cover contact part 5642, a protruding part 564a (convex shape) which protrude upward is formed. The corner of the tip end of the protruding part 564a is chamfered (see FIGS. 32 and 33).

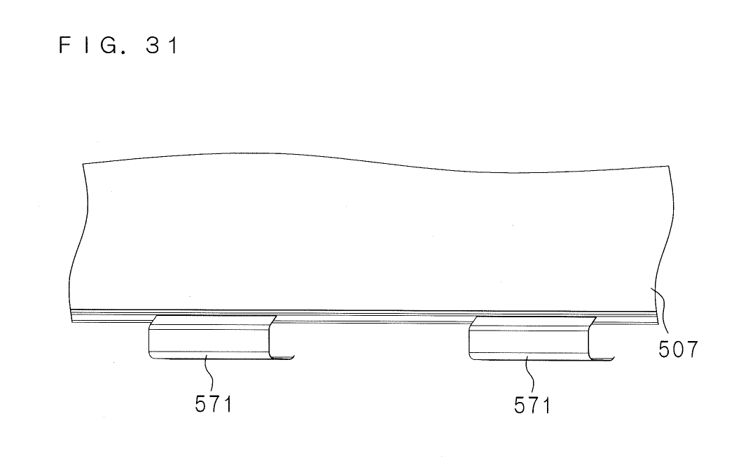

FIG. 31 is a partial perspective view of a liquid-crystal panel 507. A part of the lower part of the liquid-crystal panel 507 is shown. The lower part of the liquid-crystal panel 507 is connected to a flexible substrate 571 supplying a source signal to the liquid-crystal panel 507.

FIG. 32 is a partial perspective view illustrating the state where a liquid-crystal panel 507 is placed on an optical member holder 506. A portion on the lower side of the television receiver is illustrated. The lower end surface 507a (circumferential surface) of the liquid-crystal panel 507 is placed at a position separated from the protruding part 564a by a small distance. The tip end of the protruding part 564 is chamfered so as to facilitate the positioning of the liquid-crystal panel when the liquid-crystal panel 507 is placed on the optical member holder 506. When the liquid-crystal panel 507 is placed, its position is determined such that the lower end surface 507a of the liquid-crystal panel 507 is aligned with the tip end of the protruding part 564a of the lower side holder 564. Even if the liquid-crystal panel 507 is misaligned at some degree, the protruding part 564a which has a chamfered tip end corner may guide the liquid-crystal panel 507 so as to be placed at an appropriate position on the display panel touching part 5641 and the optical sheet 505.

When the liquid-crystal panel 507 is placed on the display panel touching part 5641 and the optical sheet 505, a groove 564b enclosed by the display panel touching part 5641, the protruding part 564a and the lower end surface 507a of the liquid-crystal panel 507. The concave part 564c is so configured that a flexible substrate 571 of the liquid-crystal panel 507 passes therethrough.

The panel cover 508 is placed on the upper surface of the liquid-crystal panel 507. Furthermore, the frame 509 tucks in and fixes the members from the backlight chassis 501 to the panel cover 508.

The panel cover 508 is a member having the shape of a rectangular frame. The panel cover 508 covers the front side peripheral part of the liquid-crystal panel 507.

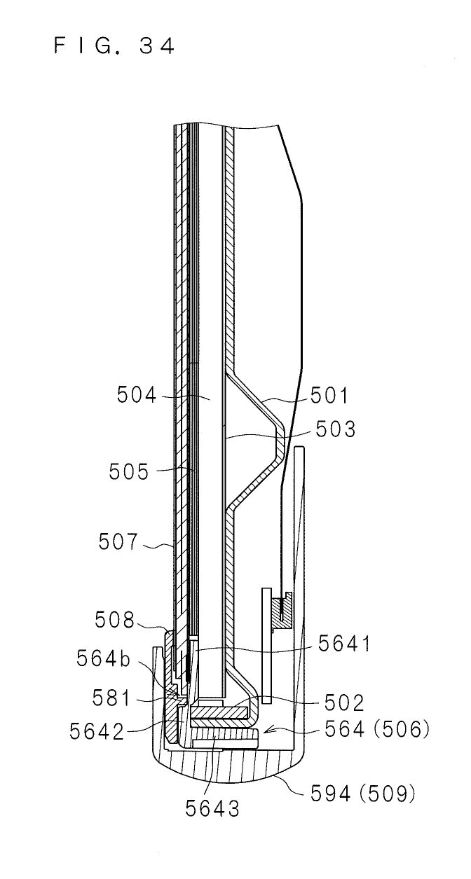

FIG. 33 is a partial perspective view along the line VI-VI in FIG. 28. FIG. 34 is a partial perspective view along the line VII-VII in FIG. 28. Both FIGS. 33 and 34 show the lower part of the television receiver. The line VI-VI runs through the protruding part 564a shown in FIG. 32. The line VII-VII runs through the groove 564b shown in FIG. 32.

On the rear surface of the plate on the lower side forming the rectangular shape of the panel cover 508, a convex part 581 extending toward the lower side holder 564 of the optical member holder 506 is provided.

In the cross section illustrated in FIG. 33, the surface of the lower side holder 564 opposed to the lower end surface 507a of the liquid-crystal panel is a tip end surface of the protruding part 564a. As the corner at the tip end of the protruding part 564a is chamfered, the liquid-crystal panel 507 may shift downward along the protruding part 564a and may run on the protruding part 564a to stick out forward. However, as illustrated in FIG. 34, a convex part 581 formed on the panel cover 508 protrudes toward the groove 564b. In the case where the liquid-crystal panel 507 shifts downward, the convex part 581 formed on the panel cover 508 supports the lower end surface 507a of the liquid-crystal panel 507. Since the panel cover 508 also presses the front side of the liquid-crystal panel 507, the liquid-crystal panel 507 runs on the protruding part 564a and further shifts downward, which can prevent it from sticking out forward.

As described above, by the convex part 581 formed on the panel cover 508 being inserted into the groove 564b enclosed by the panel cover contact part 5642 of the lower side holder 564 and the liquid-crystal panel 507, it is possible to restrict the liquid-crystal panel 507 falling off downward.

The technical features (components) described in the embodiments can be combined with one another, and a new technical feature may be formed by such combinations.

The embodiments disclosed herein are to be construed as illustrative and not limitative in all aspects. The scope of the invention is defined by the appended claims rather than by the description preceding them, and all changes that fall within metes and bounds of the claims, or equivalence of such metes and bounds thereof are therefore intended to be embraced by the claims.

### Additional Statement 21

A display apparatus, comprising: a display panel with a front surface on which an image is displayed; a light guide plate located on a rear surface side of the display panel, for outputting light entering a side surface opposed to a light emitting element to the rear surface side of the display panel to irradiate the display panel; a holding body for holding a rear surface and a circumferential surface of the light guide plate; a fixing member covering a front surface peripheral part of the light guide plate, for fixing the light guide plate to the holding body and being in contact with a part of a rear surface peripheral part of the display panel; and a frame body covering a front surface peripheral part of the display panel, characterized in that the fixing member has a plate-like part covering a front side peripheral part of the light guide plate, the plate-like part includes a periphery touching part being in contact with a rear surface peripheral part of the display panel, and a frame body contact part continuing to the periphery touching part, substantially flush with the front surface of the display panel and being in contact with the frame body, the display panel circumferential surface is separated from the frame body contact part, a grove is formed by a side surface of the frame body contact part, a portion of the periphery touching part and a circumferential surface of the display panel, and the frame body is provided with a convex part to be fitted into the groove to prevent the display panel from being out of position in a plane direction.

### Additional Statement 22

The display apparatus as described in Additional Statement 21, characterized in that the convex part is configured to protrude in a direction of the front surface of the display panel.

### Additional Statement 23

The display apparatus as described in Additional Statement 21 or 22, characterized in that the frame body contact part is provided with a projection extending in a direction of the circumferential surface of the display panel, and a tip end of the projection is chamfered.

### Additional Statement 24

A television receiver, comprising the display apparatus as described in any one of Additional Statements 22 and 23, and a reception part for receiving television broadcasts, characterized in that a video image is displayed on the display apparatus based on the television broadcasts received by the reception part.

### Embodiment 8

The present invention will be described below in detail with reference to the drawings illustrating an embodiment thereof.

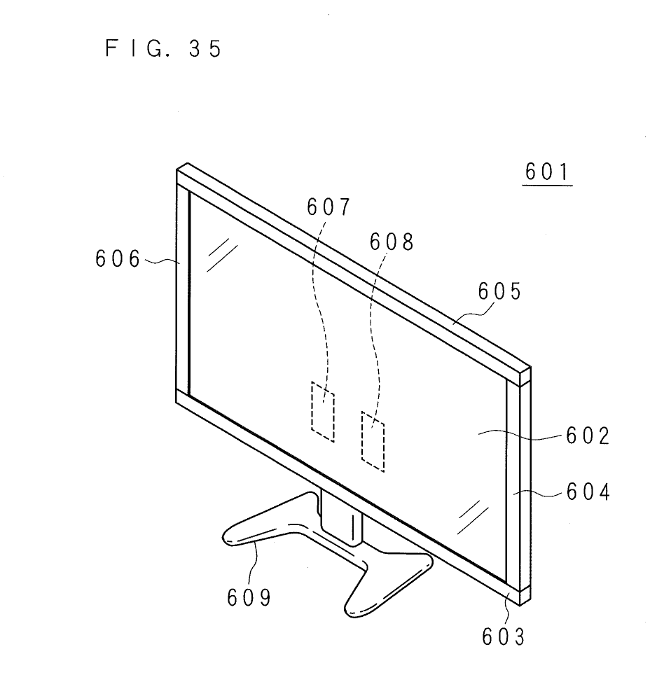

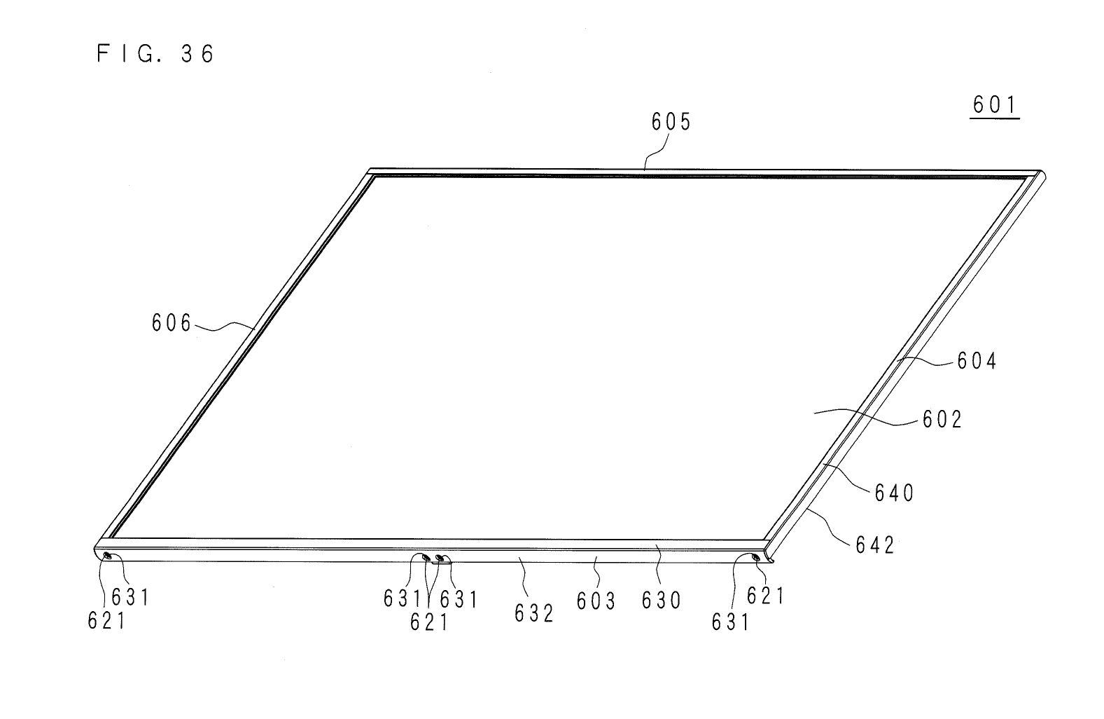

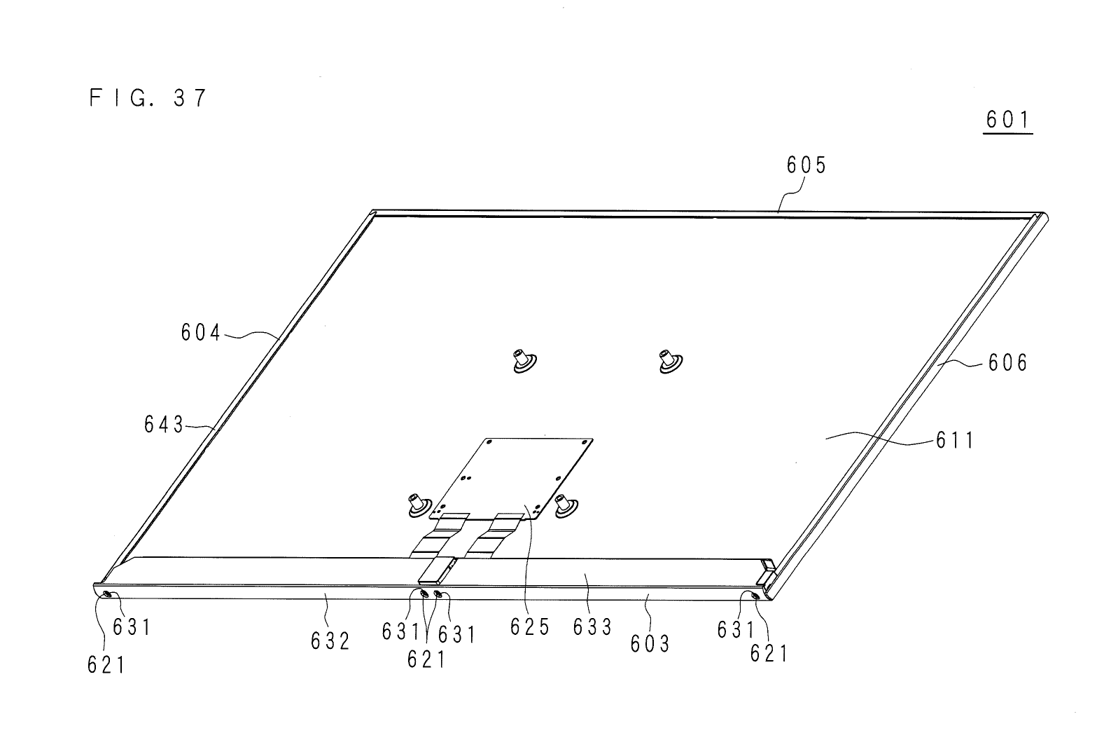

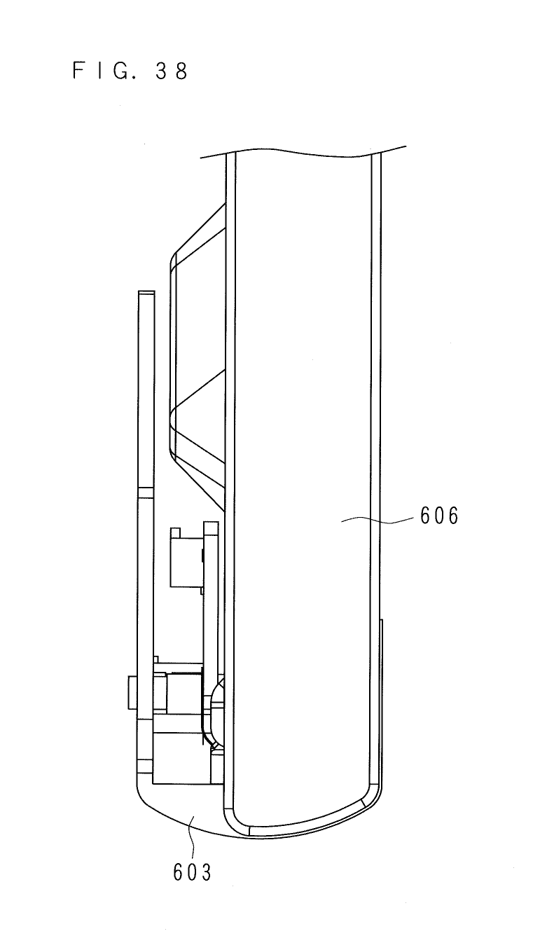

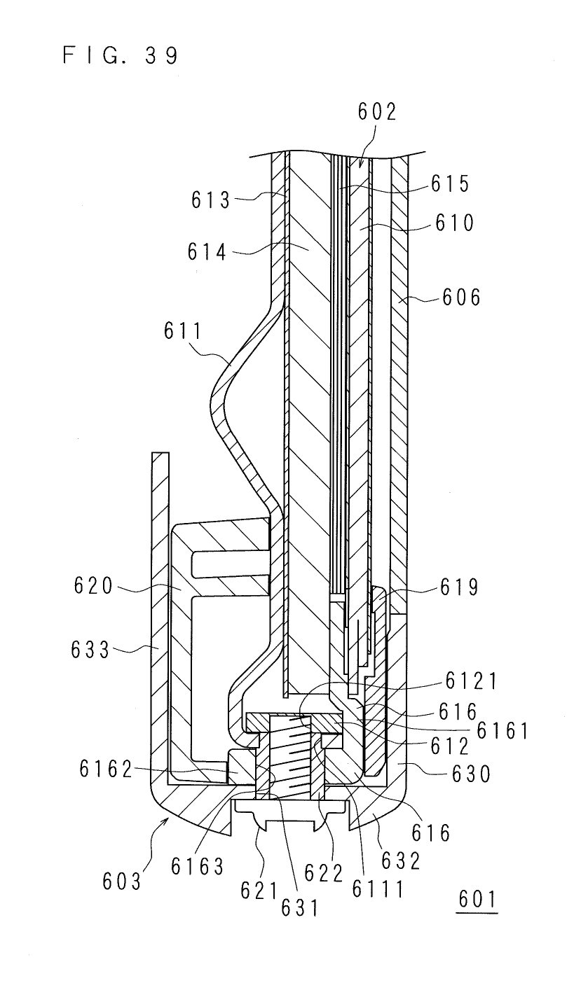

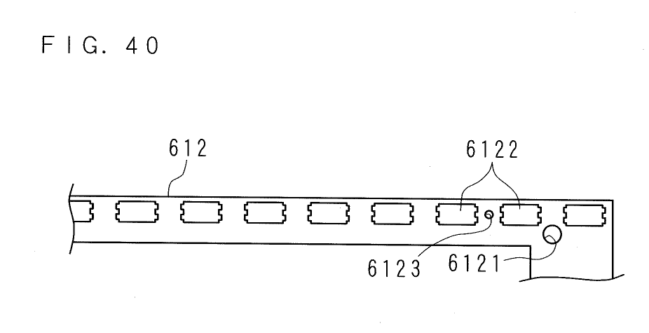

FIG. 35 is a perspective view illustrating a TV receiver 601 according to an embodiment of the present invention, FIG. 36 is an enlarged perspective view illustrating a portion excluding a stand 609 of the TV receiver 601, FIG. 37 is a back surface view illustrating the TV receiver 601, FIG. 38 is a partial side surface view illustrating the TV receiver 601 when viewed from the left side, FIG. 39 is a partial section view illustrating the TV receiver 601 when viewed from the left side, and FIG. 40 is a plan view illustrating an LED substrate 612.

The TV receiver 601 forms the shape of a horizontally long rectangular parallelepiped, including: a display module 602 placed in a vertical posture; a lower frame 603, a right frame 604, an upper frame 605 and a left frame 606 respectively covering the lower side, right side, upper side and left side (respectively corresponding to bottom, right, top and left of FIG. 35) of the display module 602; a tuner (reception part) 607 for receiving broadcast waves from an antenna (not illustrated); a decoder 608 for decoding coded broadcast waves; and a stand 609 for supporting the display module 602. The display module 602, lower frame 603, right frame 604, upper frame 605 and left frame 606 constitute the display apparatus. The display module 602 as well as the lower frame 603, right frame 604, upper frame 605 and left frame 606 constitute the display apparatus. Each of the lower frame 603, right frame 604, upper frame 605 and left frame 606 are made of, for example, an aluminum.

The lower frame 603 includes a front plate part 630 extending along the lower edge of the front surface of the display module 602, a bottom plate part 632 formed continuously and perpendicular to the front plate part 630 and extending along the bottom surface of the display module 602, and a back plate part 633 formed continuously and perpendicular to the bottom plate part 632 and extending along the lower edge of the back surface of the display module 602. The back plate part 633 is made higher than the front plate part 630.

As in the lower frame 603, the right frame 604 also includes a front plate part 640 extending along the edge of the front surface of the display module 602, a side plate part 642 formed continuously and perpendicular to the front plate part 640 and extending along the side surface of the display module 602, and a back plate part 643 formed continuously and perpendicular to the side plate part 642 and extending along the edge of the back surface of the display module 602. The upper frame 605 and left frame 606 also have configurations similar to those of the lower frame 603 and right frame 604.

As illustrated in FIG. 36, the lower end of the front plate part 640 of the right frame 604 is cut out in the L shape, the right end of the front plate part 630 of the lower frame 603 is fitted into the L-shaped cutout part, and the right frame 604 and lower frame 603 are connected with each other while the lower side of the side plate part 642 of the right frame 604 is in contact with the inner surface of the bottom plate part 632 of the lower frame 603. Similar connection manners are also applied to the right frame 604 and upper frame 605, the upper frame and left frame 606, the left frame 606 and lower frame 603.

The display module 602 includes a display panel 610, a chassis 611, an LED substrate 612, a reflection sheet 613, a light guide plate 614, optical sheets 615, a light shielding holder 616 and a panel cover 619.

The chassis 611 is made of, for example, iron, and has a substantially box-like shape with the side of the display panel 610 (front side) opened. The LED substrate 612, reflection sheet 613, light guide plate 614 and optical sheets 615 are accommodated in the chassis 611. A board on which the tuner 607, decoder 608 and the like described above are mounted is provided on the outer surface of the bottom plate of the chassis 611, the board being covered with a board cover 625. The chassis 611 may be made of synthetic resin.

The light guide plate 614 has the shape of a rectangular plate, and has a main surface opposed to the display panel 610 side, a rear surface opposed to the bottom plate of the chassis 611 at the opposite surface of the main surface, a pair of long side surfaces and a pair of short side surfaces. The light guide plate 614 is placed on the bottom plate of the chassis 611 through the reflection sheet 613. One of the long side surfaces of the light guide plate 614 functions as a light entering surface which takes in the light emitted from an LED 6122, which will be described later, of the LED substrate 612, and the light taken into the light guide plate 614 from the long side surface is output from the main surface of the light guide plate 614 toward the display panel 610 side.

The optical sheets 615 constitute a sheet group including a diffusion sheet, a lens sheet and a DBEF sheet (reflection/polarization sheet) and the like, and is placed on the main surface of the light guide plate 614. The optical sheet 615, for example, diffuses and condenses the light output from the main surface of the light guide plate 614.

The LED substrate 612 is configured to have multiple LEDs 6122 for emitting light to be taken into the light guide plate 614 on a flat surface of a substrate made of aluminum, for example, and is placed on the long side surface side at the lower side of the light guide plate 614. The LED substrate 612 extends along the long side surface, while each LED 6122 is opposed to the long side surface of the light guide plate 614. The LED substrate 612 is divided into two pieces, each of the both ends of each piece being provided with female threads 6121. A positioning hole 6123 is formed between the LEDs 6122 and 6122 at the end side.

The light-shielding holder 616 has the shape of a rectangular frame, and includes a front plate part 6161 extending along the edge of the light guide plate 614, and a side plate part 6162 continuous and perpendicular to the front plate part 6161 and extending along the long side surface of the light guide plate 614. The front plate part 6161 has a step structure in which the lower part is protruding more than the upper part. As illustrated in FIG. 39, the lower edge of the light guide plate 614 is sandwiched between the front plate part 6161 and the bottom plate of the chassis 611, while the side plate part 6162 covers the side plate on which the LED substrate 612 of the chassis 611 is placed.

The display panel 610 has a liquid-crystal layer, a pair of glass substrates and a polarization plate. The pair of glass substrates are adhered to each other through a seal material, and sandwiches the liquid-crystal layer between them. The polarization plate is placed on a surface at the opposite side of the liquid-crystal layer side of each of the pair of glass substrates.

The panel cover 619 has the shape of a rectangular frame, and is placed on the peripheral side of the display panel 610 so as to cover the edge of the display panel 610.

At the lower end of the display module 602 configured as described above, the lower frame 603 is fitted in the state where the side plate part 6162 of the light-shielding holder 616 is in contact with the inner surface of the bottom plate part 632, the panel cover 619 is in contact with the inner surface of the front plate part 630, and the chassis holder 620 is in contact with the back plate part 633 while supporting the back surface of the chassis 611.

At the bottom plate 632 of the lower frame 603, a screw insertion hole 631 is provided at each of the total four positions of the both ends and two central parts in the longitudinal direction (see FIGS. 36 and 37). Corresponding to the screw insertion hole 631, a female thread 6121 is formed on the LED substrate 612, while a screw insertion hole 6111 and screw insertion hole 6163 are formed respectively at the chassis 611 and light-shielding holder 616.

A bush 22 is fitted to each of the screw insertion holes 631, 6163 and 6111, and a screw 621 is inserted into the bush 22 and is screwed into the female thread 6121.

The assembling of the display apparatus will be described.

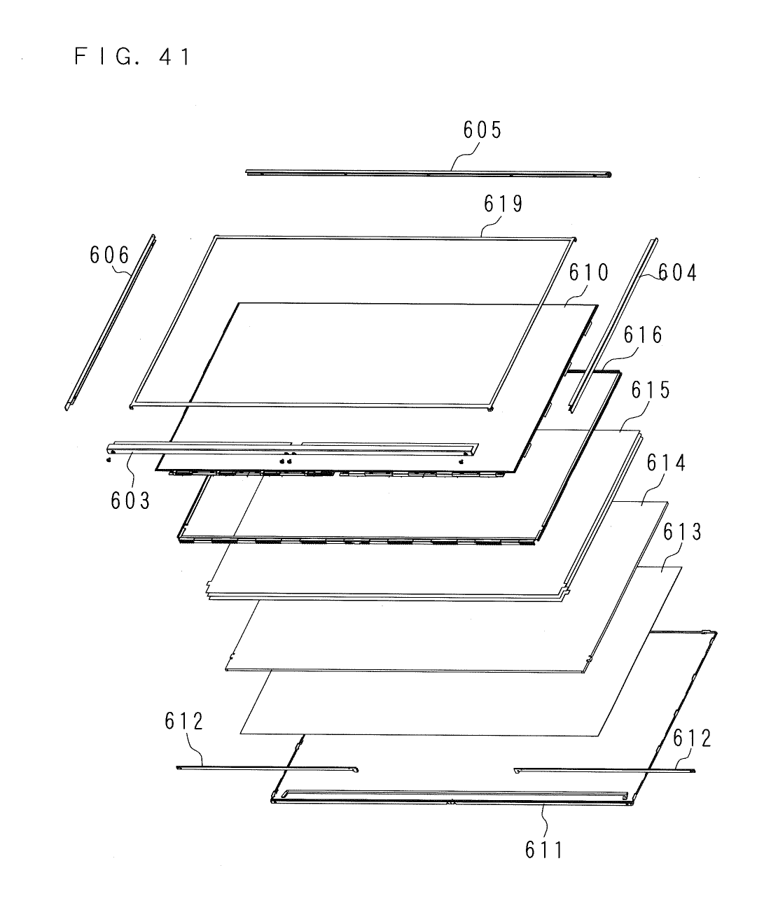

FIG. 41 is an exploded perspective view illustrating a display apparatus according to an embodiment of the present invention.

First, a positioning pin of the chassis 611 is inserted into the positioning hole 6123 to make two LED substrates 612 in contact with the side plate of the chassis 611 in the state of being temporarily attached with a double-sided tape.

Then, the reflection sheet 613 is placed on the bottom plate of the chassis 611, and the light guide plate 614 is placed on the reflection sheet 613.

Next, the light-shielding holder 616 is attached to the light guide plate 614 in the state where the inner surface of the side plate part 6162 is in contact with the outer surface of the side plate of the chassis 611 and the long side surface of the LED substrate 612 is in contact with the inner surface of the lower part of the front plate part 6161.

The optical sheets 615 are placed on the light guide plate 614, and the display panel 610 is placed on the optical sheets 615.

The panel cover 619 is fitted to the edge of the display panel 610 and the front plate part 6161 of the light-shielding holder 616.

The upper frame 605 is fitted to the upper rim of the panel cover 619, while the right frame 604 and left frame 606 are fitted to the right and left rims of the panel cover 619.

Then, the lower frame 603 is fitted into the lower part of the display module 602 in the state where the chassis holder 620 is located on the back surface of the display module 602, and each of the four screws 621 are inserted into the screw insertion hole 631 as well as the screw insertion hole 6163 of the light-shielding holder 616 and the screw insertion hole 6111 of the chassis 611, and are secured to the female thread 6121 of the LED substrate 612. When screwed, the LED substrate 612 is tightly fixed to the chassis 611 side.

In the TV receiver 601 according to the present embodiment configured as described above, the LED substrate 612 and the bottom plate part 632 of the lower frame 603 are screwed together through the side plate of the chassis 611 and the light-shielding holder 616, which can facilitate simultaneous fixing of the LED substrate 612 to the chassis 611 and fixing of the lower frame 603 to the chassis 611.

Since the LED substrate 612 is connected to the lower frame 603, the heat generated at the LED substrate 612 is preferably discharged to the lower frame 603. By interposing the light-shielding holder 616, it is possible to adjust the amount of heat dissipation by adjusting the surface area of the heat transfer path in the light-shielding holder 616.

Moreover, in the TV receiver 601 according to the present embodiment, there is no increase in the number of components and no need for a boss, which can reduce the space for fixing the lower frame 603 to the chassis 611 and the space for fixing the LED substrate 612 to the chassis 611, realizing reduction in the size and border width of the display apparatus.

Since the screw 621 is fastened from the lower frame 603 side to the LED substrate 612 while the female thread 6121 into which the shank of the screw 621 is screwed is provided at the LED substrate 612, as illustrated in FIG. 40, the screw 621 will not interfere with the gap between LEDs 6122 unlike the case where the screw head is located on the LED substrate 612, making the distance between LEDs 6122 uniform. It is, therefore, unnecessary to perform complicated adjustment for dot patterns on the light guide plate. That is, no unevenness occurs in light without the need for adjusting dot patterns.

Furthermore, according to the present embodiment, the LED substrate 612 and the lower frame 603 are configured with the same aluminum material, which will cause no distortion upon thermal expansion.

Though the present embodiment described for the case where the TV receiver 601 is a one-side edge light type, the present invention is not limited thereto. The TV receiver 601 of the present invention may also be applied to the case for a both-side edge light type.

The embodiments disclosed herein are to be construed as illustrative and not limitative in all aspects. The scope of the invention is defined by the appended claims rather than by the description preceding them, and all changes that fall within metes and bounds of the claims, or equivalence of such metes and bounds thereof are therefore intended to be embraced by the claims.

### Additional Statement 25

A display apparatus comprising a substrate on which a plurality of light emitting elements are mounted, a box having a side plate to which the substrate is attached, a display panel irradiated with light emitted from the light emitting element, and a frame covering a portion of the box including the side plate and an edge of the display panel, characterized in that the substrate and a portion of the frame opposed to the side plate are screwed together with the side plate of the box interposed in between.

### Additional Statement 26

The display apparatus as described in Additional Statement 25, characterized in that the substrate is provided with a female thread.

### Additional Statement 27

The display apparatus as described in Additional Statement 25 or 26, characterized in that a light guide plate receiving light from the light emitting element entering from a side surface and outputting the light from a main surface is accommodated in the box, the display panel is placed in a vertical posture, being opposed to the main surface, and the frame is configured to cover a part of a bottom plate of the box and a lower edge of the display panel.

### Additional Statement 28

The display apparatus as described in Additional Statement 27, comprising a holding body sandwiching an edge of the light guide plate with the bottom plate and covering the side plate, and the substrate and a portion of the frame opposed to the side plate are screwed together through the holding body and the side plate.

### Additional Statement 29

A television receiver, comprising the display apparatus as described in any one of the Additional Statements 25 to 28, and a reception part receiving television broadcasts, characterized in that a video image is displayed on the display apparatus based on the television broadcasts received by the reception part.

1-15. (canceled)

16. A display apparatus, comprising:
a display panel having a front surface on which an image is displayed;
an optical sheet is formed a convex part for positioning, protruding in a plane direction at a marginal part, placed on a rear surface side of the display panel, for diffusing light and making the light enter the display panel;
a holding body for holding the rear surface and a side surface of the display panel and forms a shape of a box; and
a positioning member having a side plate part interposed between a side surface of the optical sheet and the side surface of the holding body, and a front plate part being in parallel with a surface of the display panel is formed a cutout into which the convex part is loosely inserted, and performing positioning of the optical sheet in a plane direction.

17. The display apparatus according to claim 16, wherein
the optical sheet has a rectangular shape in a plan view, and
the convex part is formed on each of two opposing sides at the marginal part of the optical sheet.

18. The display apparatus according to claim 17, wherein the convex part is additionally formed at any one of the other two sides of the marginal part of the optical sheet.

19. The display apparatus according to claim 16, comprising:
a light emitting element for supplying light to the display panel; and
a light guide plate of which a fitting convex part is formed an outer circumference, is placed between the display panel and the optical sheet, receiving light entering from the light emitting element at a side surface of the light guide plate, and outputting the light in a direction of the rear surface of the display panel to irradiate the display panel,
wherein
a fitting concave part is formed at the side plate part, which is fitted with the fitting convex part to determine a position of the light guide plate.

20. The display apparatus according to claim 19, wherein the positioning member is configured to cover a front surface and a side surface of the light guide plate, and to shield light leaking from the light guide plate.

21. A liquid-crystal display apparatus, comprising:
a light guide plate located on a back surface of a liquid-crystal panel;
a light source substrate placed on a side surface side of the light guide plate;
a housing in which the light guide plate and light source substrate are accommodated, and an exterior component covering a front surface peripheral part of the liquid-crystal panel and a back surface of the housing; and
a light-shielding member which has a contact surface being in contact with the exterior component, and a recess is formed at the contact surface interposed between the housing and the exterior component to shield light leaking from the light source or the light guide plate to an outside.

22. The liquid-crystal display apparatus according to claim 21, wherein the contact surface of the light-shielding member has a shape of a comb or a grid.

23. The liquid-crystal display apparatus according to claim 21, wherein
the housing has a back surface part covering the back surface of the light guide plate, and a circumferential wall part provided at a circumference of the back surface part,
the light source substrate is accommodated in the housing while being in contact with an inside of the circumferential wall part,
the light-shielding member has a first portion being in contact with an outside of the circumferential wall part, and a second portion provided to be bent or curved with respect to the first portion and being in contact with the front surface peripheral part of the light guide plate, and
a side of the first portion opposite to the side being contact with the circumferential wall part is configured as a contact surface to be in contact with the exterior component.

24. The liquid-crystal display apparatus according to claim 21, wherein the light-shielding member has a thermal conductivity smaller than thermal conductivities of the housing and the exterior component.

25. The liquid-crystal display apparatus according to claim 21, wherein
the light-shielding member is an integrally-molded part made of synthetic resin, and
the housing and the exterior component are made of metal.

26. A liquid-crystal display apparatus, comprising:
one or more optical sheets arranged on a back surface of a liquid-crystal panel;
a light guide plate placed on a back surface of the optical sheet;
a light source substrate placed on a side surface side of the light guide plate;
a housing in which the light guide plate and light source substrate are accommodated, has a back surface part covering a back surface of the light guide plate and a circumferential wall part formed at a circumference of the back surface part; and
an exterior component which is configured to tuck in the liquid crystal panel and the housing, covering a front surface peripheral part of the liquid-crystal panel and a back surface of the housing, wherein
attachment of the exterior component causes the light-shielding member to press the light guide plate to a back surface side.

27. The liquid-crystal display apparatus according to claim 26, wherein
the light-shielding member includes
a panel contact surface being in contact with a back surface peripheral part of the liquid-crystal panel, and
a positioning protrusion for determining a position of the liquid-crystal panel with respect to a direction along the panel contact surface.

28. The liquid-crystal display apparatus according to claim 27, wherein
the panel contact surface is a flat surface, and
an inclined surface is formed at the positioning protrusion.

29. The liquid-crystal display apparatus according to claim 26, wherein
the circumferential wall part has a quadrangular frame shape,
the light source substrate is accommodated in the housing while being in contact with an inside of one side of the circumferential wall part, and
the light-shielding member is configured to be in contact with an outer surface of the circumferential wall part at one side, and to be in contact with an inner surface of the circumferential wall part at another side.

30. The liquid-crystal display apparatus according to claim 26, wherein
the liquid-shielding member has a frame shape,
the optical sheet is located inside the light-shielding member, and
the liquid-crystal display apparatus comprises:
one or more extension parts provided to extend from the optical sheet; and
one or more positioning concave parts formed at the light-shielding member and determining a position of the optical sheet by accommodating the extension part or extension parts.
